(19) United States
(12) Patent Application Publication
(10) Pub. No.: US 2017/0069175 A1
(43) Pub. Date: Mar. 9, 2017

(54) GAMING MACHINE

(71) Applicants: Universal Entertainment Corporation, Tokyo (JP); Aruze Gaming (Hong Kong) Limited, Kowloon (HK)

(72) Inventors: Kenta KITAMURA, Tokyo (JP); Atsuya TAKANO, Tokyo (JP); Akira OSAWA, Tokyo (JP)

(73) Assignees: Universal Entertainment Corporation; Aruze Gaming (Hong Kong) Limited

(21) Appl. No.: 15/260,733

(22) Filed: Sep. 9, 2016

(30) Foreign Application Priority Data
Sep. 9, 2015 (JP) 2015-177327

(51) Int. Cl. G07F 17/34; G07F 17/32

(52) U.S. Cl. CPC G07F 17/34; G07F 17/3209; G07F 17/3213; G07F 17/3246; G07F 17/3206; G07F 17/3258

(57) ABSTRACT

The present invention provides a gaming machine which is possible to set a sound easily which is a desired sound of a setter of the gaming machine. The gaming machine includes a liquid crystal display device displaying a setting screen by which a plurality of effect setting items including a sound category of a game are set, and a speaker outputting a sound. In the gaming machine, the setting screen displays a plurality of effect setting items in a selectable manner, and when an effect setting item of a sound category is selected from the plurality of effect setting items, multiple themes associated to the effect setting item is displayed in a selectable manner, and when one of the multiple themes is selected, the liquid crystal display device displays an audition button image which is used to perform a sound test of the theme.

### CROSS-REFERENCE TO RELATED APPLICATION

This application claims priority from Japanese Patent Application No. 2015-177327, filed on Sep. 9, 2015, which application is incorporated herein by reference in its entirety.

### FIELD OF THE INVENTION

The present invention relates to a gaming machine.

### BACKGROUND OF THE INVENTION

In a specification of the US Unexamined Patent Publication No. 2013/0196737, a gaming machine executing a normal game and giving the normal game a corresponding payout is disclosed, wherein starting the normal game when a bet is accepted. Generally, such gaming machine performs an effect achieved by, for example, a sound, an LED, an effect image, a reel action, etc., according to a game state such as a game result and the like.

In the known gaming machine, the effect may be changed in a setting screen. In general, a display of the setting screen is performed with a key switch, which uses a key held by a manager who manages the gaming machine, and the manager sets various setting items, and thereby the effect may be changed.

### BRIEF SUMMARY OF THE INVENTION

However, it is difficult to understand what a content of selection objects of the various setting items is according to the setting screen of the known gaming machine, which may be difficult for a manager not used to it to change the content into a desired setting.

Therefore, the purpose of the present invention is to provide a gaming machine which is more possible to set a desired content easily.

The gaming machine of the present invention includes:

a display device including a touch panel and displaying a setting screen by which a plurality of effect setting items including sound category of a game are set;

a controller controlling the setting screen according to an input to the touch panel;

a memory in which each of the plurality of effect setting items is associated with multiple themes, and a setting content corresponds to each of the multiple themes of the each of the plurality of effect setting items; and

a speaker outputting the sound,

wherein the controller:

causes the setting screen to display the plurality of effect setting items in a selectable manner; causes the setting screen to display the multiple themes in a selectable manner, when one of the plurality of effect setting items is selected;

causes the display device to display an audition button image when a selected effect setting item is a category of the sound and one of the multiple themes is selected; and

causes the speaker to output a sound of the setting content corresponding to the selected theme, when the audition button image is touched.

According to the arrangement above, the effect content can be changed for each effect setting item by performing a choice from the plurality of themes common to a plurality of effect setting items, and an audition is performed in the setting screen when the effect setting item is a category of a sound. Therefore, it may save the time to check the sound by actually running the game, and it is possible to set a sound easily which is a desired sound for a setter of the gaming machine.

Besides, in the gaming machine of the present invention, the controller performs an ON/OFF control to an output of the sound of the speaker each time the audition button image is touched, and the audition button image is displayed in a highlighted manner when the output of the sound is ON.

According to the arrangement above, the audition button image is highlighted when the speaker outputs a sound. Therefore, it is possible to avoid the following issue, that is, a setter of the gaming machine could not understand whether the audition button image is pressed or not when ambient environment is of much noise.

The present invention may provide a gaming machine which is possible to set a sound easily which is a desired sound for a setter of the gaming machine.

### BRIEF DESCRIPTION OF THE DRAWINGS

FIG. 1 is an illustrative diagram showing an action of a slot machine.

FIG. 2 is an illustrative diagram showing a functional flowchart of the slot machine.

FIG. 3 is an overall structural diagram of a gaming system.

FIG. 4 is a stereogram of the slot machine.

FIG. 5 is an illustrative diagram showing a PAY LINE of the present implementation.

FIG. 6 is an illustrative diagram showing a meter group of a liquid crystal display device.

FIG. 7 is an illustrative diagram showing a setting item screen displayed in the liquid crystal display device.

FIG. 8 is an illustrative diagram showing a setting content selection screen displayed in the liquid crystal display device.

FIG. 9 is an illustrative diagram showing a sound test screen displayed in the liquid crystal display device.

FIG. 10 is an illustrative diagram showing a sound test screen displayed in the liquid crystal display device.

FIG. 11 is an illustrative diagram of a reel action category setting table.

FIG. 12 is an illustrative diagram of a reel action occurrence condition table.

FIG. 13 is an illustrative diagram of a first sound category setting table.

FIG. 14 is an illustrative diagram of a second sound category setting table.

FIG. 15 is an illustrative diagram of a graphic category setting table.

FIG. 16 is an illustrative diagram of an LED category setting table.

FIG. 17 is an electrical block diagram in the slot machine.

FIG. 18 is a diagram showing an example of a winning combination.

FIG. 19 is a diagram showing an example of a progressive payout.

FIG. 20 is a diagram showing an example of a progressive payout.

FIG. 21 is a diagram showing an example of a progressive payout.

FIG. 22 is a diagram showing an example of a progressive payout.

FIG. 23 is a diagram showing an example of a progressive payout.

FIG. 24 is an illustrative diagram showing a bet arrangement table.

FIG. 25 is an illustrative diagram showing an example of a display state of a payout table displayed in an upper image display panel.

FIG. 26 is an illustrative diagram showing an example of a display state of a payout table displayed in the upper image display panel.

FIG. 27 is an illustrative diagram showing an example of a display state of a payout table displayed in the upper image display panel.

FIG. 28 is an illustrative diagram showing an example of a display state of a payout table displayed in the upper image display panel.

FIG. 29 is an illustrative diagram showing an example of a display state of a payout table displayed in the upper image display panel.

FIG. 30 is an illustrative diagram showing an example of an effect state displayed in the upper image display panel when a payout is performed.

FIG. 31 is an illustrative diagram showing an example of an effect state displayed in the upper image display panel when a payout is performed.

FIG. 32 is an illustrative diagram showing an example of an effect state displayed in the upper image display panel when a payout is performed.

FIG. 33 is an illustrative diagram showing an example of an effect state displayed in the upper image display panel when a payout is performed.

FIG. 34 is an illustrative diagram showing an example of an effect state displayed in the upper image display panel when a payout is performed.

FIG. 35 is an illustrative diagram showing an example of a liquid crystal display device game message area.

FIG. 36 is a diagram showing a flowchart of a main control process of the slot machine.

FIG. 37 is a diagram showing a flowchart of a bet/start check process of the slot machine.

FIG. 38 is a diagram showing a flowchart of an effect setting process of the slot machine.

### DETAILED DESCRIPTION OF THE PREFERRED EMBODIMENT

A gaming machine of the present invention is illustrated according to the drawings.

Summary of the Gaming Machine

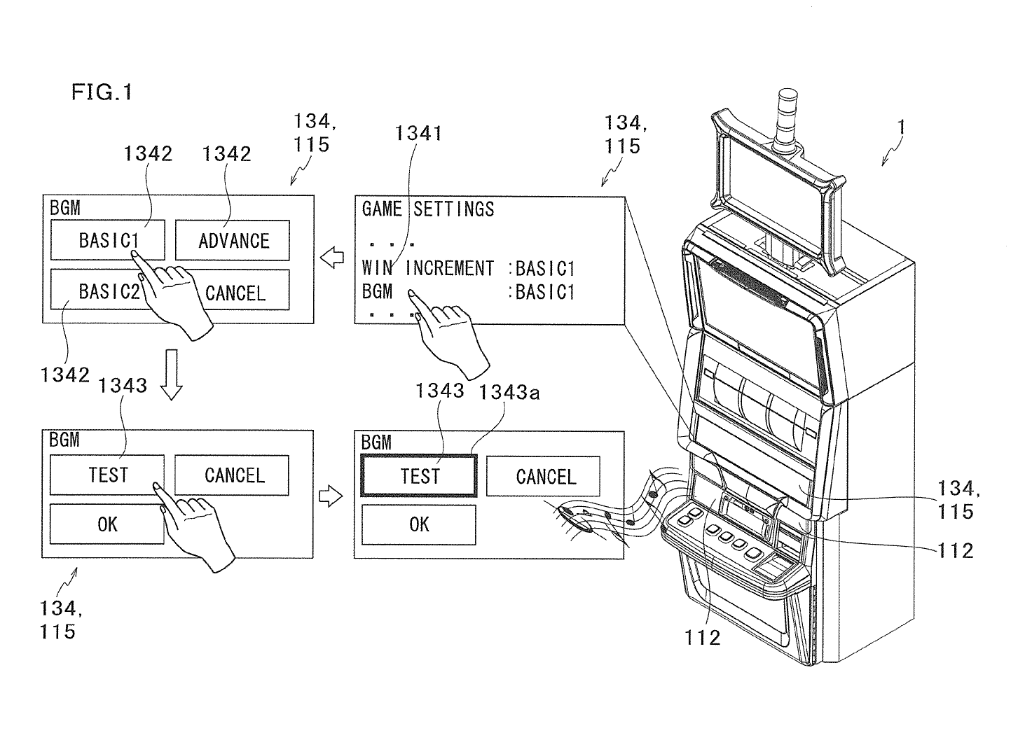

As shown in the FIG. 1, a slot machine 1 of the gaming machine as an embodiment of the present invention includes a touch panel 115, a liquid crystal display device 134 as a display device displaying a setting screen which may set a plurality of effect setting items including a sound category of a game, and a speaker 112 outputting a sound. The slot machine 1 is configured to control a setting screen of the liquid crystal display device 134 according to an input to the touch panel 115. Each one of the plurality of effect setting items in the slot machine 1 is associated to a plurality of themes and is stored. Besides, in the slot machine 1, each one of the plurality of themes associated to the plurality effect setting items corresponds to a setting content and is stored.

The slot machine 1 displays the plurality of effect setting items in a selectable manner in the setting screen. And, the slot machine 1 displays a plurality of themes 1342 in a selectable manner when one effect setting item is selected from the plurality of effect setting items 1341 displayed in the setting screen. Also, the slot machine 1 causes the liquid crystal display device 134 to display an audition button image 1343, when the selected effect setting item 1341 is a sound category and one theme is selected from the plurality of themes 1342 displayed in the setting screen. Further, the slot machine 1 causes the speaker 112 to output a sound of the setting content corresponding to the selected theme, when the audition button image 1343 is touched.

As such, the effect content can be changed for each effect setting item by performing a choice from the plurality of themes common to a plurality of effect setting items, and an audition is performed in the setting screen when the effect setting item is a sound category. Therefore, it may save the time to check the sound by actually running the game, and it is possible to set a sound easily which is a desired sound for a setter of the gaming machine.

In the slot machine 1, an ON/OFF control is performed to an output of a sound of the speaker 112 when the audition button image is touched, and a frame image 134 is shown around the audition button image to highlight the audition button image when the output of a sound is ON.

As such, the audition button image is highlighted when the speaker outputs a sound. Therefore, it is possible to avoid the following issue, that is, a setter of the gaming machine could not understand whether the audition button image is pressed or not, when ambient environment is of much noise.

(Definition, etc.)

The above slot machine is one of gaming machines. In the present embodiment, the slot machine 1 is illustrated as an example of a gaming machine, but it is not limited thereto, as long as a device which can perform a certain normal game independently.

A game in the present embodiments is executed by the slot machine 1. A normal game and a free game are slot games rearranging a plurality of symbols. Besides, the rearrangement of the symbols is performed by a mechanical reel unit in the slot game.

The symbols indicate a general term of “TRIPLE NUTTY JACKPOT”, “DOUBLE NUTTY JACKPOT”, “RED7”, “3BAR”, “2BAR”, “BAR” and “BLANK”.

Besides, it is not limited to a bonus payout, and a free game which is triggered in the normal game may be also performed. The normal game is a game in which the symbols are rearranged in a display window by a mechanical reel unit in the condition of a bet of a credit value and a prize corresponding to the rearranged symbols is given. In other words, the normal game is a game started with a precondition of a bet of a credit value. The free game means to a game performed under a less bet of credit value compared with the normal game. The “performed under a less bet of credit value” includes a case of the bet being zero. In the present embodiment, the “free game” means a game performed without a condition of a bet of a credit value. In other words, the “free game” means a game started without a precondition of a consumption of a credit value.

Further, a free game in the present embodiment is performed when a precondition in a normal game comes into existence. The free game is a game which is more advantageous than the normal game in a game state. If it is a game state benefiting a player, that is, a game state more advantageous than the normal game, it may be used along with another free game. For example, the free game may be achieved by one or combinations of the following various states, that is, a state in which a more gaming value is obtained than a normal game, a state in which a possibility of obtaining a gaming value is greater than a normal game, and a state in which a consumption amount of a gaming value is less than a normal game, etc.

Gaming value (credit value) is an electronic information of price as electronic money, etc. Besides, there is no particular limitation to the gaming value in the present invention, for example, it may be a gaming media of a coin, a medal, a token, a ticket, etc. There is no particular limitation to a ticket, and for example, it may be a ticket with a bar code, and the bar code is formed by coding a data of a credit value, etc. Further, the “gaming value” may be a game point which does not have an information of price.

The “rearrangement” means a state in which symbols are rearranged after the arrangement of the symbols is relieved. The “arrangement” means a state in which a player outside of the device confirms the symbols through a visual method. Specifically, the “rearrangement” means a state in which a reel stops rotating and a scroll-display of symbols stops after the symbols on the reel scroll- display as the reel rotates, and thereby the symbols stop within the display window.

### Illustration of the Functional Flowchart

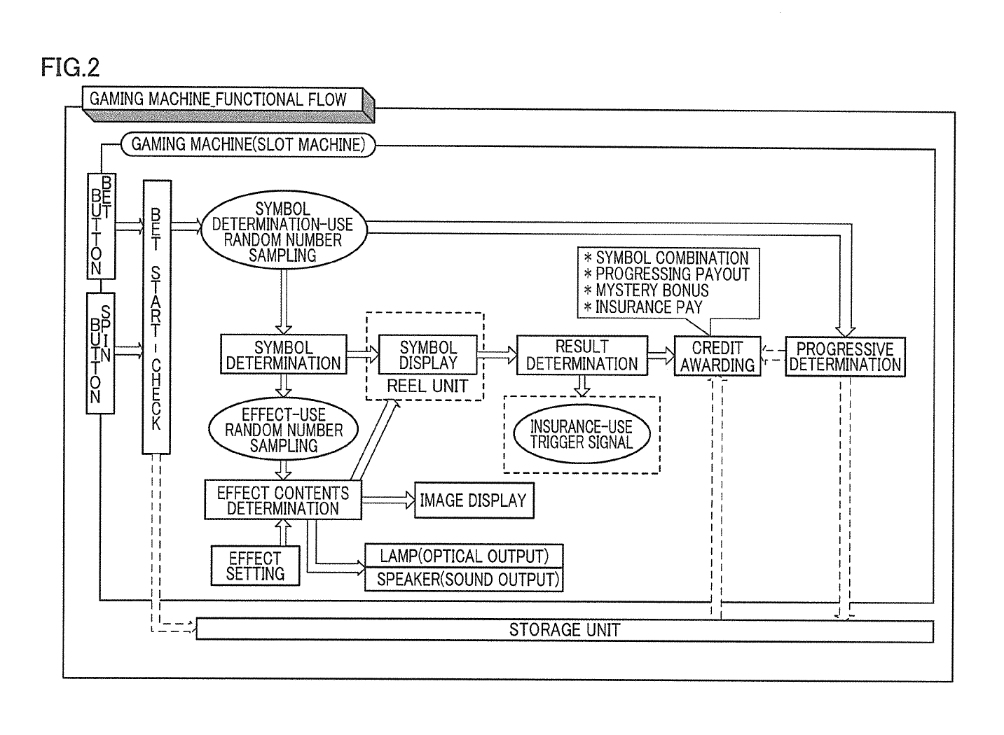

Refer to the FIG. 2, fundamental function of the slot machine of an embodiment of the present invention is illustrated. FIG. 2 is an illustrative diagram showing a functional flowchart of the slot machine of an embodiment of the present invention.

(Bet/Start Check)

First, the slot machine checks whether a BET button is pressed by a player, and then checks whether a spin button is pressed by a player. Further, the slot machine accumulates and adds a portion of a jetton amount of a bet into a progressive payout stored in a storage unit in each normal game (a unit game).

(Symbol Determination)

Next, the slot machine extracts a random number for symbol determination when the spin button is pressed by a player, and symbols displayed (rearranged) in a display device are determined when the reel stops rotating according to each reel in a plurality of reels.

(Reel Control)

Next, the slot machine rotates various reels and controls the various reels to stop them to display the determined symbols into the display device.

(Winning Determination)

Next, the slot machine judges whether a combination of the symbols displayed in the display device is winning when the various reels stop rotating.

(Prize Awarding)

Next, the slot machine gives the player a prize corresponding to the kind of a combination of the symbols when the combination of the symbols displayed in the display device is winning. For example, the slot machine gives the player a number of credit corresponding to a combination of the symbols when displaying the combination of the symbols associated to giving a credit.

Further, the slot machine judges whether a progressive payout is given according to a combination of the symbols associated to a free game trigger. Then, the slot machine gives the player a payout amount of a progressive payout stored in the storage unit, in the case of determining to give a progressive payout under a progressive random determination.

Besides, except the above prize, a prize such as mystery bonus, insurance and the like may be disposed in the slot machine. The mystery bonus means that a credit of a predetermined sum is given if it is winning under a special purpose random determination. In this situation, the slot machine extracts a mystery bonus random number and determines whether a mystery bonus trigger comes into existence through the random determination when the spin button is pressed.

The insurance is a function set for the purpose of relieving a player when a free game has been not performed for a long time. The insurance is exchanged with a predetermined insurance activation amount when the insurance is validated. The slot machine starts to count the games after the insurance is validated. Then, the slot machine gives a credit for the insurance of a determined quota after the counted games reach the predetermined times without giving a big amount of credit based on a free game and the like.

(Effect Determination)

The slot machine performs an effect by an action of a reel unit, an image display of a display device, light output of a light and sound output of a speaker. The slot machine extracts an effect-use random number and determines a content of the effect according to symbols determined by the random determination. In the present embodiment, a content of the effect is determined according to a theme set for various effect setting items in the setting screen.

(Overall Structural of a Gaming System)

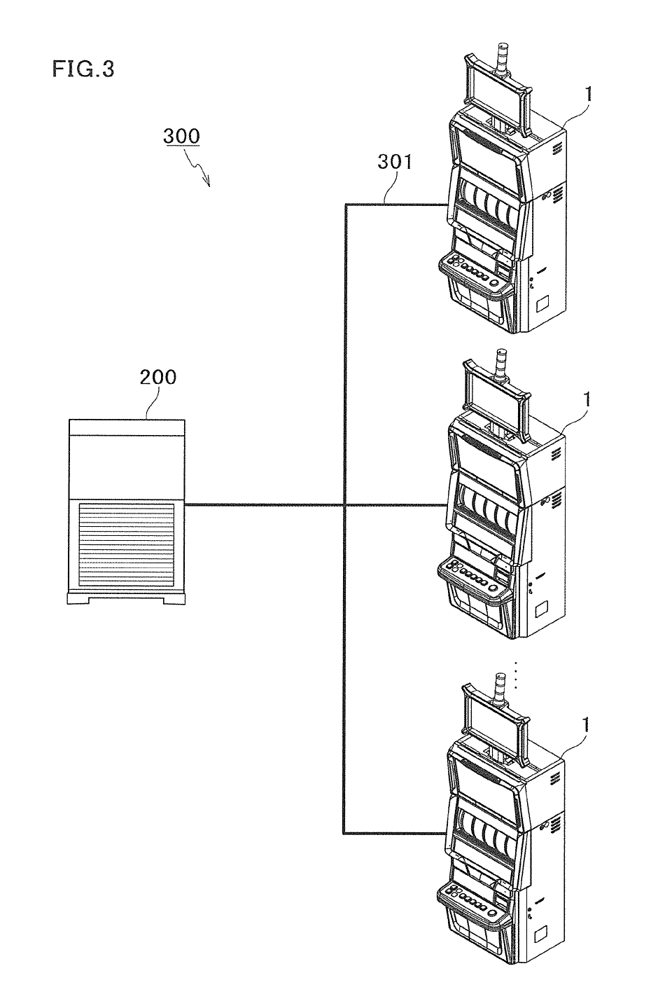

The fundamental function of the slot machine is illustrated above. Next, refer to the FIG. 3, a gaming system including a slot machine therein is illustrated. FIG. 3 is a diagram showing a gaming system including a slot machine of the present embodiment.

A game system 300 includes a plurality of slot machines 1 and an external controller 200 connected with the slot machines 1 through a communication line 301.

The external controller 200 controls the plurality of slot machines 1. In the present embodiment, the external controller 200 is a so-called hall server which is disposed in a game device with a plurality of slot machines 1. Inherent identifiers are given to the slot machines 1, and external controller 200 distinguishes where a data sent by each slot machine 1 comes according to the identifiers. Further, a destination where to send is designated with the identifier when the external controller 200 sends data to the slot machine 1.

Further, the game system 300 may be disposed within one game device such as a casino and the like which can perform various games and may be also disposed among a plurality of game devices. Besides, the game system 300 may be disposed in each layer or each section of a game device when it is disposed within one game device. The communication line 301 may be a wire or a wireless, and a special purpose loop line or an exchange loop line and the like may be adopted.

(Overall Structure of the Slot Machine)

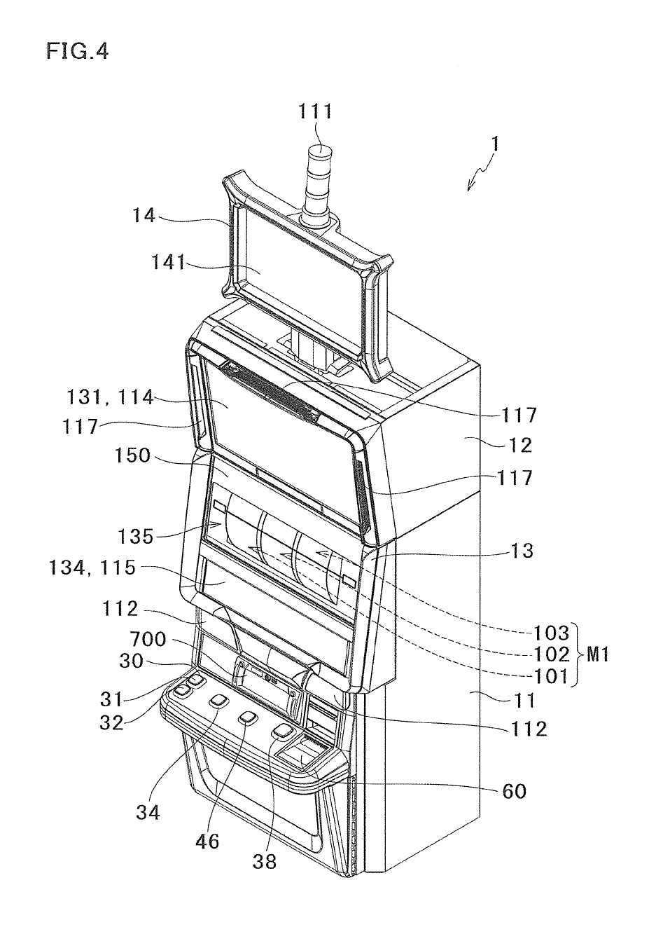

Next, refer to the FIG. 4, the overall structure of the slot machine is illustrated. FIG. 4 is an illustrative diagram showing an overall structure of the slot machine of an embodiment of the present invention.

In the slot machine 1, an electronic information of price of an electronic money and the like is adopted as a gaming value. Further, the gaming value is not limited to the above, for example, a coin, a medal, a token, a ticket with a bar code and the like may be also adopted.

The slot machine 1 includes a cabinet 11, a top box 12 disposed at upper side of the cabinet 11, and a main door 13 disposed at frond side of the cabinet 11.

A reel unit M1 composed of three reels 101, 102 and 103 is disposed in the main door 13. A reel cover 135 is disposed at front surface of the reel unit M1. Further, a liquid crystal display device 134 or a transparent panel is disposed under the reel cover 135 for reporting a game state to a player. A touch panel 115 is disposed in the liquid crystal display 134. A display window 150 is disposed at a center of the reel cover 135.

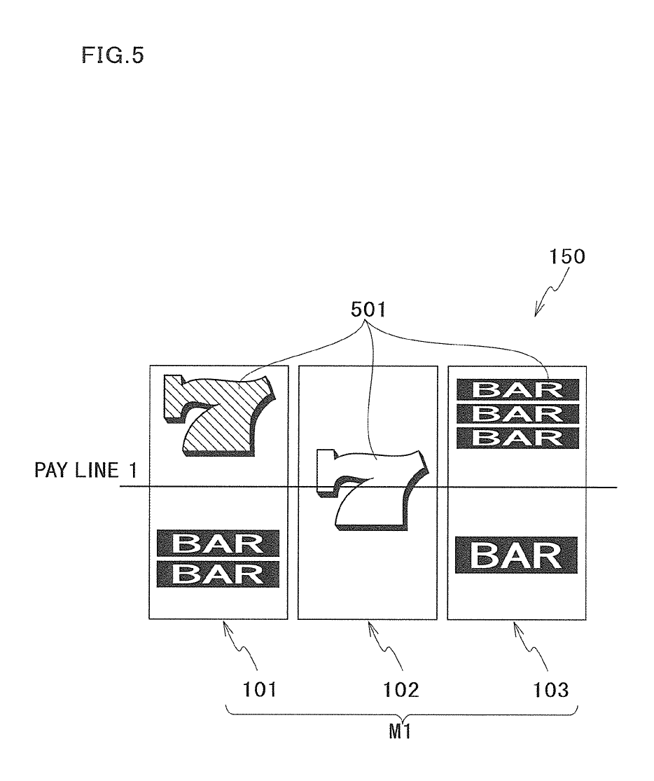

As shown in the FIG. 5, one symbol 501 is displayed in each of three regions which are an upper stage, a middle stage and a lower stage of the display window 150 corresponding to each of the reels 101-103. That is to say, total nine symbols 501 of three rows and three columns are displayed visibly in the display window 150. A plurality of symbols 501 are depicted on periphery surfaces of the reels 101, 102 and 103. The symbols 501 are continuously configured along a rotation direction of the reels 101, 102 and 103, forming a symbol column. Further, a speaker 112 is disposed on the main door 1003.

As shown in the FIG. 5, a PAY LINE is disposed in the slot machine 1 to perform a winning judgment for the symbols 501 rearranged in the display window 150. One PAY LINE set at the middle stage of the reels 101-103 is formed in the present embodiment. In the present embodiment, it is winning when three symbols of a same kind of each of “TRIPLE NUTTY JACKPOT”, “DOUBLE NUTTY JACKPOT”, “RED7”, “3BAR”, “2BAR”, and “1BAR” are rearranged on the PAY LINE. Besides, it is winning when three symbols of each of “3BAR”, “2BAR”, and “1BAR” are rearranged on the PAY LINE. Further, the “TRIPLE NUTTY JACKPOT” and “DOUBLE NUTTY JACKPOT” function as wild symbols which may replace the “RED7”, “3BAR”, “2BAR”, and “1BAR”.

Further, in the following explanation, a winning based on the PAY LINE may be termed as a line winning, and a winning based on a scattered form is termed as a scattered winning.

Further, a bonus payout is given when a winning of “TRIPLE NUTTY JACKPOT” is reached as an MAX bet. The bonus payout may be set as validated/invalidated. Further, a progressive payout is given to a player when the “TRIPLE NUTTY JACKPOT” and “DOUBLE NUTTY JACKPOT” are rearranged with a predetermined state. The progressive payout may be set to be validated/invalidated. Further, the “BLANK” is a symbol without a pattern which is different from the other symbols and is configured between other symbols. Further, it is not limited thereto, and a plurality of PAY LINEs may be also set. And, it may be also configured to validate each of a plurality PAY LINEs according to a choice of a player.

The reels 101, 102 and 103 are stopped rotating after being driven rotatively by the reel unit M1, so as to rearrange the symbols 501 into the display window 150, wherein the symbols 501 are disposed on periphery surfaces of the reels 101, 102 and 103. Further, in the following explanation, they may be termed as the first reel 101, the second reel 102 and the third reel 103 from the front to the back and from the left to the right successively.

A back light unit (not shown) is disposed at internal sides of the reels 101, 102 and 103 configured as the above. The back light unit is configured to emit an illumination light from the internal sides to the periphery surfaces of the reels 101, 102 and 103, and the illumination light through the periphery surfaces of the reels may be visible from the outside of the display window 150. The back light unit is formed to be a structure which may make an amount of light when the illumination light emits multi-levelly change, so as to a degree of freedom of an effect implemented with the illumination light may be improved. Further, the back light unit may emit multi-colored light and irradiate an illumination light for the symbols.

Further, in the present embodiment, a situation that the slot machine 1 including the reel unit M1 in a form of a mechanical reel is illustrated, however the slot machine 1 of the present invention may be also in a form of a video reel showing a simulated reel and may further be in a combination of a video reel and a mechanical form.

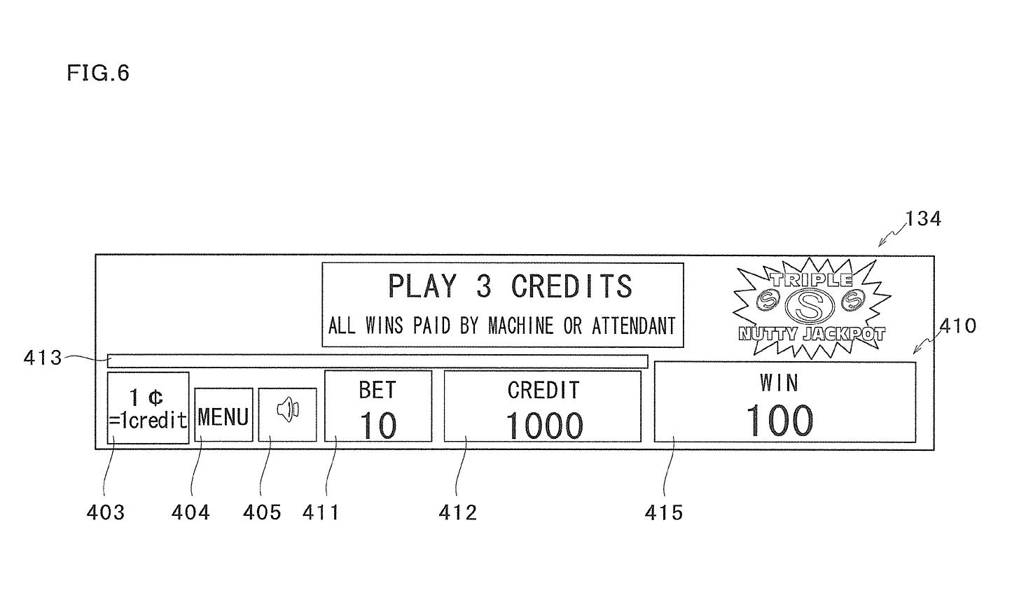

As shown in the FIG. 6, the liquid crystal display device 134 displays a meter group 410 used to report a title of a game and a state of the game. The meter group 410 is composed of a bet meter 411, a credit meter 412, a game state display region 413 and a WIN meter 415. The bet meter 411 displays a total bet amount of the whole bet. For the total bet amount, its number is recalculated for each game play. The credit meter 412 displays a current total credit amount. For the number of the total credit amount, its initial value is zero, and it will increase or decrease according to a input gaming value, a bet and a game result. The game state display region 413 displays a message used to explain a current game state. For example, a game state and a bet/line messages are displayed in the game state display region 413. The WIN meter 415 performs an increment display for the total credit of the obtained prize.

A denomination indicator 403, a menu touch icon 404 and a sound volume touch icon 405 are displayed at the left bottom of the liquid crystal display device 134. A preset current denomination is displayed in the denomination indicator 403. Specifically, the display appears at two stage of upper stage and lower stage, money or a game point is displayed at the upper stage, and a credit amount corresponding to the money or the game point displayed at the upper stage is displayed at the lower stage. Further, it may be also configured to switch the denomination according to a touch input of a player. A three-grade switch may be performed for a game sound volume by the sound volume touch icon 405. The sound volume of a game switches as an order from low ->middle ->high ->low ->middle ->. . . when touching. The menu touch icon 404 is used to display a language selection and a game rule.

Further, the liquid crystal display device 134 displays a setting screen (audit) used to perform various settings of a game. A manager may perform an input for the slot machine 1 through the touch panel 115 according to a displayed audit menu, so as to set an effect content and the like. The setting of the effect content will be detailed below. Various settings may be also achieved by setting the audit, for example, a setting change of a country set to the slot machine 1 and the like.

A topper unit 14 is disposed on upper sidewall of a top box 12. The topper unit 14 has a liquid crystal panel 141 by which an image related to an effect or the like is displayed. The above liquid crystal panel 141 of the topper unit 14 is configured to display a logo representing the above slot machine 1 and the like, and a player away from the slot machine 1 can also confirm a setting position of the above slot machine 1. Further, a lamp 111 is disposed at upper portion of the topper unit 14.

An upper image display panel 131 (equivalent to a display device) is disposed at front side of the top box 12. The upper image display panel 131 is formed of a liquid crystal panel, forming a display device. The upper image display panel 131 displays an image used to represent an image related to an effect, a game content introduction and a game rule explanation. Further, a touch panel 114 is disposed within the upper image display panel 131. Various instructions may be input by a player through touching the upper image display panel 131.

An LED unit 117 is disposed at both sides and upper of the upper image display panel 131, and the LED unit 117 surrounds the upper image display panel 131.

A control panel 30, a PTS unit 700 and a bill entry 60 are disposed under the reel unit Ml, wherein the control panel 30 is configured with various buttons.

The bill entry 60 identifies whether a bill is suitable, accepts a genuine paper money and puts it into the cabinet 11. The bill entry 60 is electrically with the PTS unit 700, which sends an input signal based on a sum of a genuine bill to the PTS unit 700 after accepting the bill. The input signal includes information such as a credit data and the like related to the accepted bill.

PTS unit 700 is a unit integrally formed of an LCD (liquid crystal display), a human body detect camera, microphone and the like. The human body detect camera may detect whether there is a player by the function of a camera. The microphone may allow a player to join a game through a voice or authenticate a player by a voice identification. Further, an insert card slot is disposed in the PTS unit 700, and an IC card may be inserted through the insert card slot. Therefore, a player may insert an IC card into the insert card slot and use a credit stored in the IC card in the slot machine 1.

(Control Panel 30)

A HELP button 31 and a CASHOUT button 32 are relatively disposed in a left side region, a BET button 34 and a spin button 46 are disposed in a center region, and an MAX BET button 38 is relatively disposed in a right side region in the control panel 30.

The HELP button 31 is a button pressed when a game operating method is not understood and the like, and various help information is displayed in the upper image display panel 131 and the like when the HELP button 31 is pressed. CASHOUT button 32 is an operation button used when liquidating the credit stored within the slot machine 1.

A bet amount increases one by one when the BET button 34 is pressed each time, until a preset MAX bet amount is reached. After the bet amount reaches the MAX bet, the bet amount return back to one when the BET button 34 is pressed. A game starts with a bet amount determined by the BET button 34 when the spin button 46 is pressed. A game starts with a preset MAX bet when the MAX BET button 38 is pressed. The MAX bet amount may be determined by auditing. For example, the MAX bet amount may be selected from 3, 5, 9, 10, 15, 20, 30, 40, 50. As mentioned above, a bet receiving mechanism is composed of various buttons configured in the control panel 30. The reels 101, 102 and 103 start to scroll when the MAX BET button 38 or the spin button 46 is pressed.

(Audit Menu)

Here, settings based on the audit is illustrated concretely. For example, a manager inserts a key (AUDIT key) into a key slot, which is not shown, of the slot machine, and turns the key (AUDIT key), and thereby a setting of the above audit may be performed in an audit menu displayed in the liquid crystal display device 134 (audit device) and the like. The display of the audit menu in the liquid crystal display device 134 is illustrated concretely below.

(Audit Menu: Setting Item Screen)

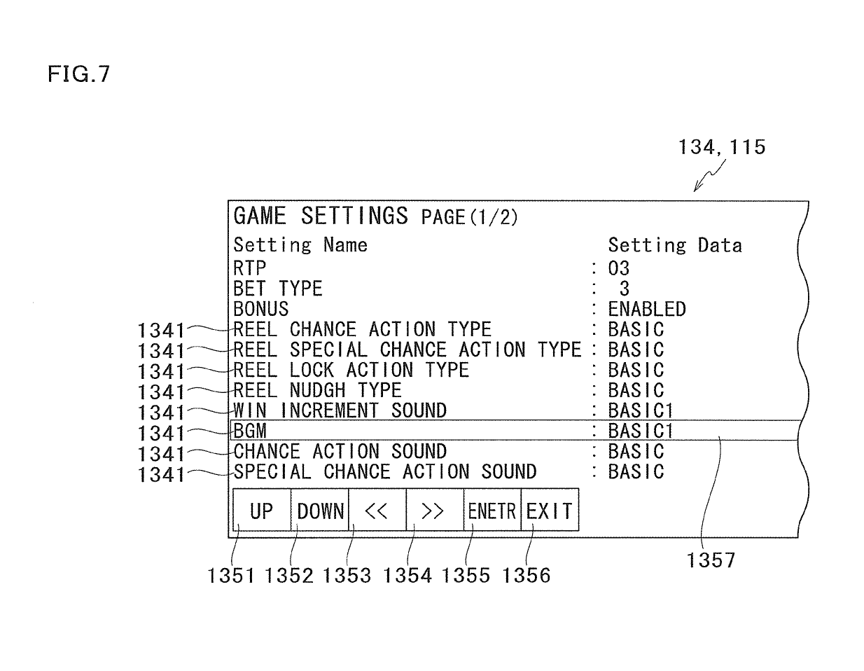

FIG. 7 represents a setting item screen of the audit menu. A desired setting item to be set may be selected by a setter in the setting item screen. Setting items of a plurality of categories are displayed in a selectable manner in the setting item screen.

Specifically, a plurality of setting items including the effect setting item 1341 are displayed in the setting item screen. Each setting item is identifiable by name. Further, a setting content in the current setting is shown in the setting item.

Each setting item may be selected by touching and may be also selected by operating an operation button displayed at lower portion of the setting item screen. Specifically, an UP button 1351, a DOWN button 1352, a page return button 1353, a page fast forward button 1353, an ENTER button 1355 and an EXIT button 1346 are shown at lower portion of the setting item screen.

The UP button 1351 is a button used to move a selected object toward an upward direction. The DOWN button 1352 is a button used to move a selected object toward a downward direction. Further, a cursor image 1357 is displayed in a selecting item which is a selected object currently. The page return button 1353 is a button used to display a setting item screen of a previous page. The page fast forward button 1354 is a button used to display a setting item screen of a next page. As mentioned above, a setting item may be displayed in a plurality of screens, and all setting items may be also displayed in one screen. The ENTER button 1355 is a button used to select a setting item. A setting item which is displaying the cursor image 1357 is selected and a screen for setting the setting item is entered when the ENTER button 1355 is touched. The EXIT button 1346 is a button used to set the setting item screen to be non-display and return to a game screen.

(Audit Menu: Setting Content Selection Screen)

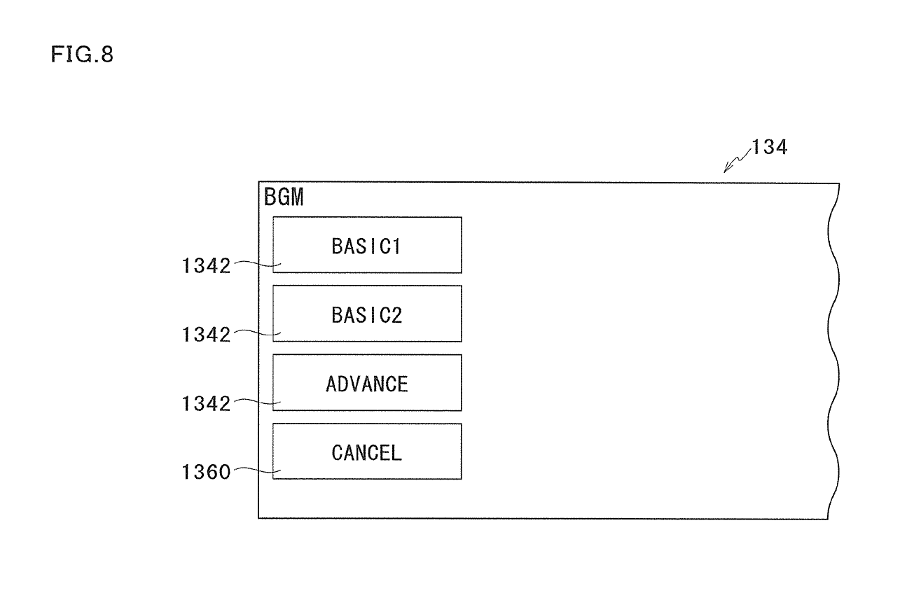

As shown in the FIG. 8, a setting content selection screen is entered when selecting a setting item in the setting item screen. Here, it is illustrated that a setting item of a sound category is selected in the setting item screen. A plurality of themes 1342 to be selected as a setting content of a setting item are displayed in the setting content selection screen. Further, a CANCEL button 1360 is displayed in the setting content selection screen. The CANCEL button 1360 is used to return to the setting item screen in a state of keeping a setting content without changing a setting content of a setting item.

(Audit Menu: Sound Test Screen)

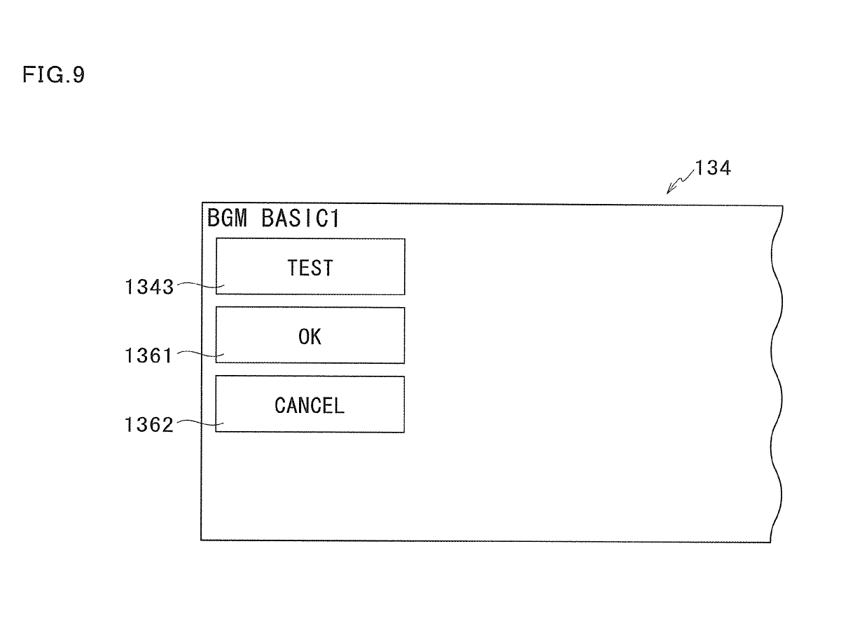

As shown in the FIG. 9, a sound test screen is entered when a certain theme 1342 is selected in the setting content selection screen of a setting item related to a sound category. An audition button image 1343, an OK button 1361 and a CANCEL button 1362 are displayed in the sound test screen. The OK button 1361 is a button used to determine a setting item as a setting content selected in the setting content selection screen and return to the setting item screen. The audition button image 1343 is a button used to listen a sound (setting item) selected in the setting content selection screen. The CANCEL button 1362 is used to return to the setting content selection screen in a state of keeping a setting content without changing a setting content of a setting item.

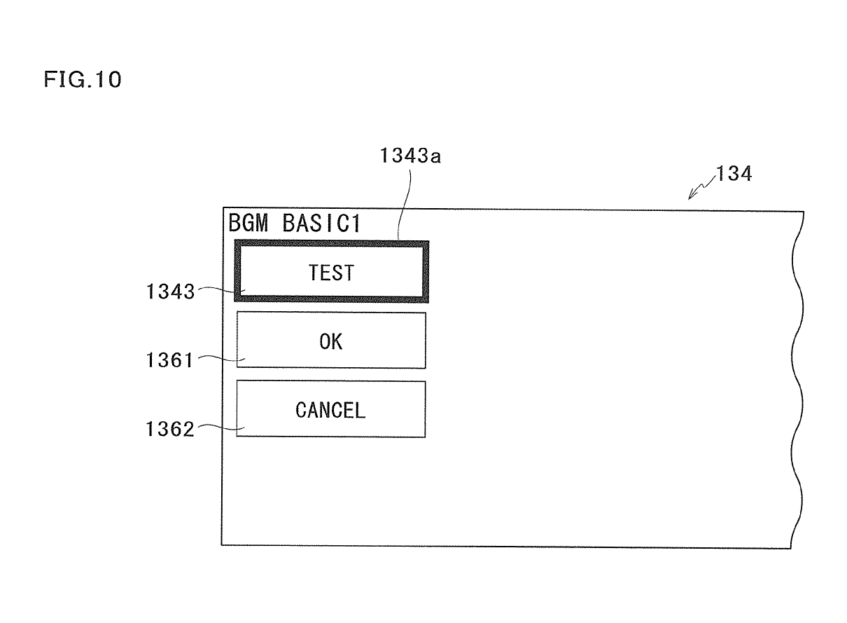

As shown in the FIG. 10, a sound selected in the setting content selection screen is output by the speaker 112 and a frame image 1343A (for example, orange color) is shown around the audition button image 1343 when the audition button image 1343 is touched. That is to say, the audition button image 1343 is displayed in a highlighted manner when a sound is output from the speaker 112. The highlighted display is not limited thereto, and it may change the color of the whole region of the audition button image 1343 and may also display an enlarged character “TEST” given to the audition button image 1343. The speaker 112 stops outputting a sound when the audition button image 1343 is touched again during the sound is output from the speaker 112, and a highlighted display of the audition button image 1343 is changed to be not displayed (refer to the FIG. 9). As mentioned above, an ON/OFF control is performed to a sound output of the speaker 112 whenever the audition button image 1343 is touched. Further, the OK button 1361 may be validated only when the sound output of the speaker 112 is OFF. Further, the CANCEL button 1362 may be validated only when the sound output of the speaker 112 is OFF. A grayout display may be performed to a character “OK” given to the OK button 1363 and a character “CANCEL” given to the CANCEL button 1362 during the OK button 1361 and the CANCEL button 1362 are invalidated.

Further, if it is not the setting content selection screen related to a setting item of a sound category, the setting item is determined as the selected setting content and the screen is changed to be a setting item screen when the setting content is selected in the setting content selection screen.

(Audit Menu: Illustration Regarding the Category and the Theme)

A category is set for a setting item of an effect as the above sound in the setting item. Specifically, in the present embodiment, there are “a reel action”, “a first sound”, “a second sound”, “a graphics” and “an LED” as the category. Also, a plurality of themes may be selected for various categories. As such, each effect setting item is associated with a plurality of themes, and a setting content corresponds to each of the plurality of themes of each of the plurality of effect setting items. The setting content of each of various categories stored in a memory (subsequent SSD unit 55, ROM 72, RAM 73 and the like) is illustrated below.

Further, the reel action indicates an effect gesture of the reels 101, 102 and 103. The sound (the first sound and the second sound) indicates a music and an effect sound output from the speaker 112. The graphics indicates an effect image displayed in the upper image display panel 131. The LED indicates a luminous mode of a back light unit disposed at internal sides of the reels 101, 102 and 103 and the LED unit 117 disposed around the upper image display panel 131.

<Reel Action Category>

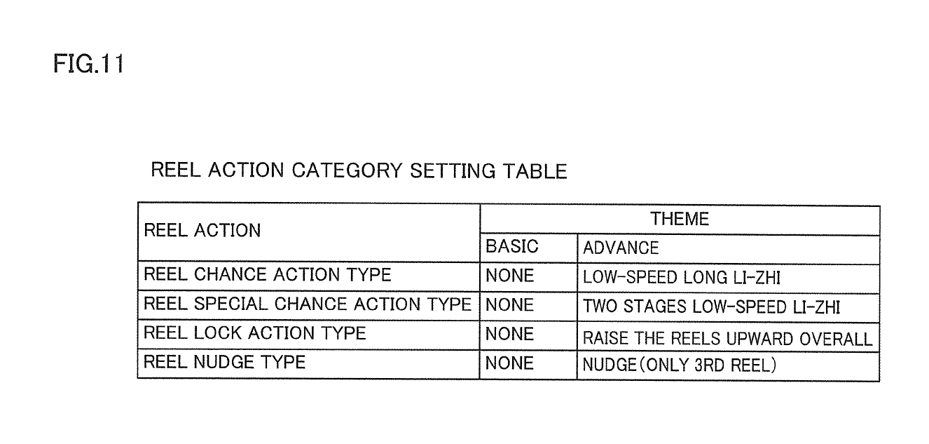

As shown in the FIG. 11, each of the setting items of the reel action effect is associated to two themes, “BASIC” and “ADVANCE” in the reel action category setting table. That is to say, an effect content may be selected from the “BASIC” and “ADVANCE” in the setting items included in the reel action category. The setting items included in the reel action category are “REEL CHANCE ACTION TYPE”, “REEL SPECIAL CHANCE ACTION TYPE”, “REEL LOCK ACTION TYPE” and “REEL NUDGE TYPE”.

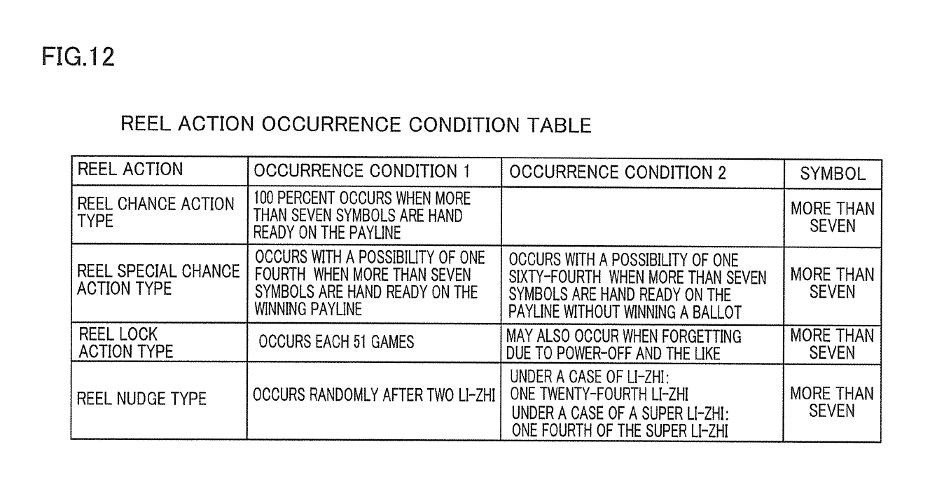

As shown in the FIG. 12, an occurrence condition is set for various setting items. That is to say, the setting of the reel action indicates a setting in which what reel action is performed when a certain occurrence condition comes into existence. Specifically, a certain setting item of the reel action is also “NONE” when the “BASIC” is selected. That is to say, an effect based on the reel action is not performed even if a certain occurrence condition comes into existence when the “BASIC” is set for various setting items. Further, a reel action of a setting content set in the reel action category setting table (FIG. 11) is performed when an occurrence condition set in the reel action occurrence condition table (FIG. 12) comes into existence when the “ADVANCE” is set for various setting items.

For example, an occurrence condition of the “REEL CHANCE ACTION TYPE” comes into existence when symbols (“RED7”, “TRIPLE NUTTY JACKPOT”, “DOUBLE NUTTY JACKPOT”) bringing a payout more than RED7 are ready hand on the PAY LINE. At the moment, an effect based on the reel action is not performed when the “BASIC” is set in a setting item of the “REEL CHANCE ACTION TYPE”. Further, a reel action which is rotated slower and for a longer time (Low-Speed Long Li-Zhi) than a normal condition is performed in the third reel 103, when the “ADVANCE” is set in a setting item of the “REEL CHANCE ACTION TYPE”. Further, in the present embodiment, ready hand (lizhi) indicates that if a predetermined symbol stops on a PAY LINE of the third reel 103, the first reel and the second reel stop in a state that a prize occurs in the condition that only the third reel 103 rotates.

<Sound Category>

In the present embodiment, a sound is divided into two categories, a first sound and a second sound.

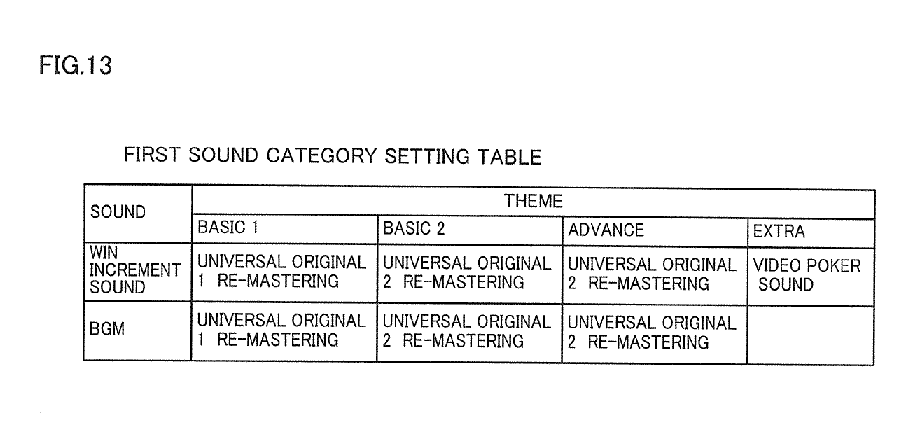

As shown in the FIG. 13, each of setting items of the first sound effect is associated to three themes, that are, “BASIC1”, “BASIC2” and “ADVANCE” in the first sound category setting table. That is to say, an effect content may be selected from the “BASIC1”, “BASIC2” and “ADVANCE” in the setting items included in the first sound category. Further, setting items included in the first sound category are “WIN INCREMENT SOUND” and “BGM”.

Further, for the “WIN INCREMENT SOUND”, it is associated to “EXTRA” themes except for the above three themes. Therefore, the setting content selection screen displays four themes 1342, that are, “BASIC1”, “BASIC2”, “ADVANCE” and “EXTRA”, when a setting item of the “WIN INCREMENT SOUND” is selected in the setting item screen of the audit menu. As mentioned above, a setting content is easily reflected into the setting screen by relating a theme corresponding to the setting content with the stored setting item. That is to say, a theme corresponding to a setting content is read in the stored setting item and the setting content is reflected into the setting content selection screen when the setting content selection screen is displayed.

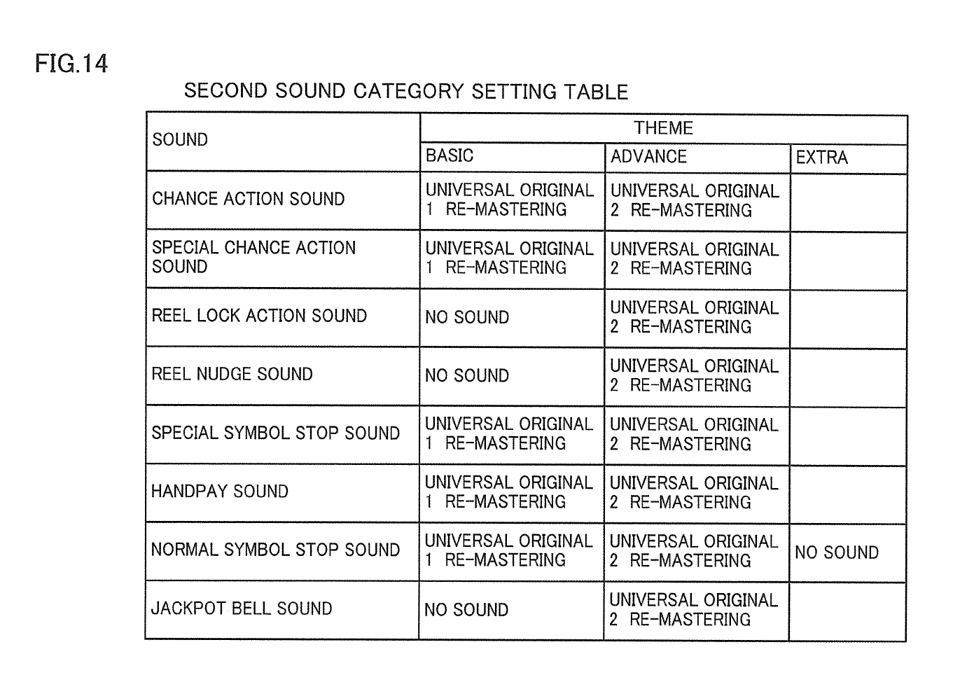

As shown in the FIG. 14, each of the setting items of the second sound effect is associated to two themes “BASIC” and “ADVANCE” in the second sound category setting table. That is to say, an effect content may be selected from the “BASIC” and “ADVANCE” in the setting items included in the second sound category. Further, setting items included in the second sound category are “CHANCE ACTION SOUND”, “SPECIAL CHANCE ACTION SOUND”, “REEL LOCK ACTION SOUND”, “REEL NUDGE SOUND”, “SPECIAL SYMBOL STOP SOUND”, “HANDPAY SOUND”, “NORMAL SYMBOL STOP SOUND” and “JACKPOT BELL SOUND”.

Further, for the “NORMAL SYMBOL STOP SOUND”, it is associated to “EXTRA” themes except for the above three themes. Therefore, the setting content selection screen displays three themes “BASIC”, “ADVANCE” and “EXTRA”, when a setting item of the “NORMAL SYMBOL STOP SOUND” is selected in the setting item screen of the audit menu.

Further, a setting content of the “BASIC” of the “REEL LOCK ACTION SOUND”, “REEL NUDGE SOUND” and “JACKPOT BELL SOUND” and the “EXTRA” of the “NORMAL SYMBOL STOP SOUND” is “non-sound”. Therefore, sound of these setting items would be output when the above themes are selected in these setting items. In this case, a sound may be not output when the audition button image 1343 is touched in the sound test screen. However, a setter can understand that a sound he/she wants to set is a non-sound when the setter observes that a frame image 1343A is displayed around the audition button image 1343.

<Graphics Category>

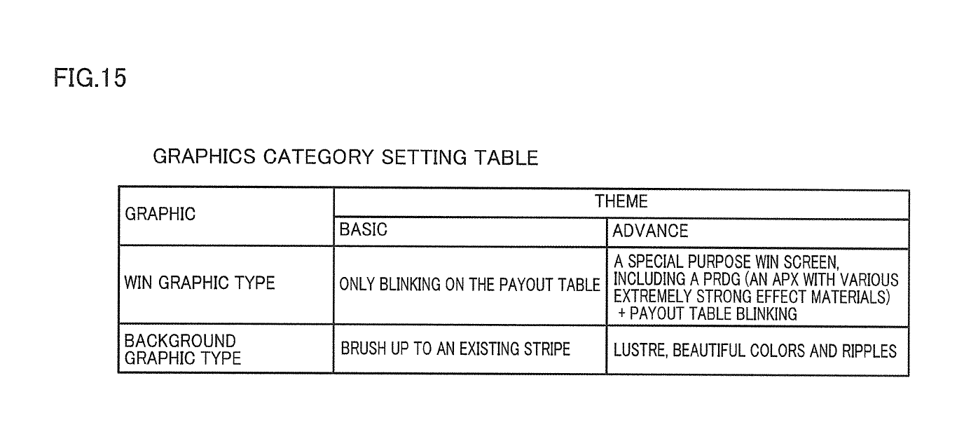

As shown in the FIG. 15, each of setting items of the graphics effect is associated to two themes “BASIC” and “ADVANCE” in the graphics category setting table. That is to say, an effect content may be selected from the “BASIC” and “ADVANCE” in the setting items included in the graphics category. Further, the setting items included in the second sound category are “WIN GRAPHIC TYPE” and “BACKGROUND GRAPHIC TYPE”.

<LED Category>

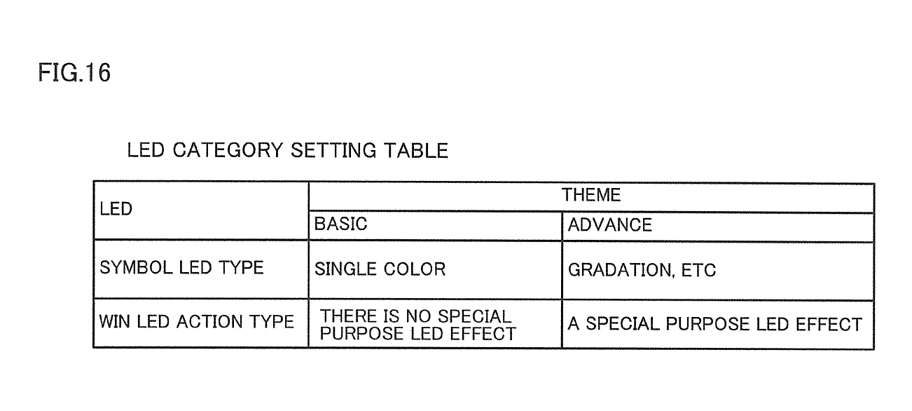

As shown in the FIG. 16, each of setting items of the LED effect is associated to two themes “BASIC” and “ADVANCE” in the LED category setting table. That is to say, an effect content may be selected from the “BASIC” and “ADVANCE” in the setting items included in the LED category. Further, setting items included in the second sound category are “WIN GRAPHIC TYPE” and “BACKGROUND GRAPHIC TYPE”.

As mentioned above, various categories have same themes therein, the “BASIC (the BASIC1 and BASIC2 in the first sound)” and the “ADVANCE”. In the present embodiment, an effect of a uniform style is set. For example, effects such as a simple (pure) effect, a short time effect, a retro effect and the like are set for the “BASIC”. Further, effects such as a complex effect, a long time effect, a fashionable effect and the like are set for the “ADVANCE”. Therefore, a person setting the slot machine 1 may set the slot machine 1 by unifying themes of various setting items, and thus performing a uniform effect. Further, each setting item is individually settable, and therefore, only some of the setting items may be changed.

(Audit Menu: Other Setting Items)

Further, a reward rate (RTP: Return to Player), a bet type, whether there is a progressive payout and whether there is a bonus payout may be also set in the audit menu. For the reward rate, it may be selected from a plurality of reward rates registered in advance. The bet type is a setting item used to determine an MAX bet amount, and it may be selected from a plurality of bet types registered in advance. Whether there is a progressive payout is a setting item used to determine whether a progressive payout is given when a plurality of rearranged symbols are in a predetermined state. The progressive payout is validated only when it is the MAX bet. Whether there is a bonus payout is a setting item used to determine whether a payout is superadded when winning with symbols of the highest payout. The bonus payout is validated only when it is the MAX bet.

(A Circuit Structure Included in a Slot Machine)

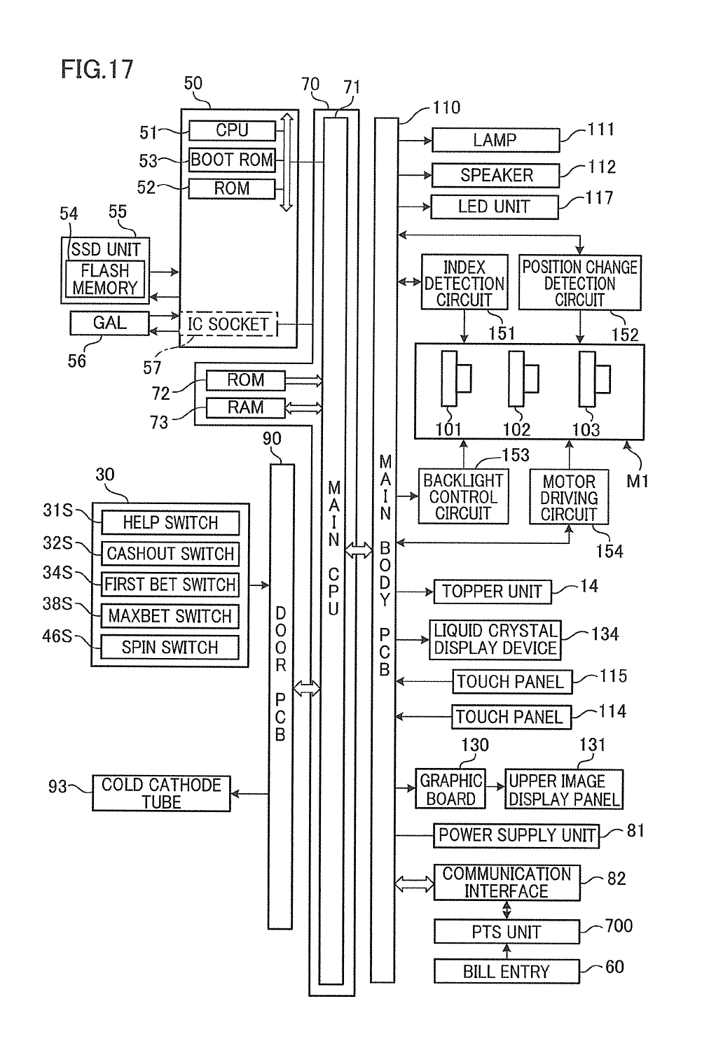

Next, refer to the FIG. 17, a circuit structure included in the slot machine 1 is illustrated. FIG. 17 is a block diagram showing an internal structure of a slot machine of an embodiment of the present invention.

A gaming board 50 includes a CPU 51, a ROM 52 and a boot ROM 53 connected with each other through an internal bus and an IC socket 57 corresponding to a GAL (GENERIC ARRAY LOGIC) 56. Further, the gaming board 50 may be connected with an SSD (SOLID STATE DRIVE) unit 55.

The SSD unit 55 is a storage unit having a flash memory 54 and connected along with the gaming board 50 removable. There are various game program stored in the above flash memory 54. The game program includes a program related to a game execution and an effect program used to perform an effect based on an image, a sound and an LED or the like. In the present embodiment, a first game program and a second game program are stored in the flash memory 54. And, it is configured that a game program executed in the slot machine 1 by the setting of the audit is a program selected from the first game program and the second game program. That is to say, it is configured that a content (game state) of a game executed in the slot machine 1 by the setting of the audit may change.

In the present embodiment, by the setting of the audit, the slot machine 1 may execute a game without performing the above progressive random determination when the first game program is selected. On the contrary, by the setting of the audit, the slot machine 1 may execute a game with the above progressive random determination to be performed when the second game program is selected. As mentioned above, a game state may be switched by the setting of the audit, therefore a suitable game state may be selected according to the setting condition of the slot machine and the like. Hereafter, a game state may be also termed as a progressive off state when the slot machine 1 executes the first game program, and a game state may be also termed as a progressive on state when the slot machine 1 executes the second game program.

In addition, a game content executed in the slot machine 1 may be changed by rewriting the program stored in the flash memory 54 into another program or replacing the flash memory 54 with the SSD unit 55 in which another program is stored.

The GAL 56 is one of PLD (PROGRAMMABLE LOGIC DEVICE) including an OR fixed type array arrangement. The GAL 56 has a plurality of input ports and output ports, and a corresponding data may be output from the output port once a predetermined input is applied to the input port.

Further, the IC socket 57 is configured as the removable GAL 56 and is connected to a motherboard 70 through a PCI bus.

The CPU 51, the ROM 52 and the ROM 53 connected through the internal bus are connected to the motherboard 70 through the PCI bus. The PCI bus is used to transmit a signal between the motherboard 70 and the gaming board 50 and may be used to supply power to the gaming board 50 from the motherboard 70.

An authentication program is stored in the ROM 52. A preliminary authentication program, a program (boot code) booting the preliminary authentication program by the CPU 51 and the like are stored in the boot ROM 53. The authentication program is a program used to authenticate a game program (falsification check program). The preliminary authentication program is a program used to authenticate the above authentication program. The authentication program and the preliminary authentication program are described as a procedure of an authentication whether a program which is an authentication object is tampered to be an authentication content.

The motherboard 70 has a main CPU 71, a ROM 72, a RAM 73 and a communication interface 82. The ROM 72 and the RAM 73 function as a storage unit.

The ROM 72 is composed of a storage unit such as a flash memory and the like, in which a program executed by the main CPU 71, such as a BIOS and the like, and a permanent data are stored. A predetermined initial treatment is performed to peripheral devices when the BIOS is executed by the main CPU 71. Further, at the moment, a get-in treatment is performed to a game program stored in the SSD unit 55 through the main CPU 71 and the gaming board 50.

In addition, a controller of the present invention is configured as including the above main CPU 71, ROM 72, RAM 73 and SSD unit 55 storing a game program and controlling the slot machine through the main CPU 71 executing the game program. Of course, the above controller is not limited to the arrangement above, and a structure where the game program is stored in the ROM 72 in advance but not in the SSD unit 55 may be also adopted.

A date and a program used when the main CPU 71 gestures are stored in the RAM 73. For example, the above game program and authentication program may be stored after a get-in treatment is performed to them. Further, a region operating when the above program is executed is disposed in the RAM 73. For example, a region for storing game times, a bet amount and an awarded credit amount of a normal game and the like, a region for storing a symbol (code number) determined by a random determination and the like are disposed.

The communication interface 82 is used to communicate with the PTS unit 700 and the external controller 200. The PTS unit 700 sends a credit data included in an input signal to the main CPU 71 through the communication interface 82 after accepting the input signal from the bill entry 60. Further, the PTS unit 700 sends a credit data stored in an IC card to the main CPU 71 through the communication interface 82 when the IC card is inserted into an insert card slot. In addition, the PTS unit 700 writes a credit data into an IC card inserted in the insert card slot according to a control signal received from the main CPU 71 through the communication interface 82.

In addition, aftermentioned door PCB (PRINTED CIRCUIT BOARD) 90 and body PCB 110 are connected to the motherboard 70. And, a power unit 81 is connected to the motherboard 70. The main CPU 71 of the motherboard 70 starts when a power supplied to the motherboard 70 from the power unit 81, and a power is supplied to the gaming board 50 through the PCI bus, and the CPU 51 starts.

An input device such as a switch, a sensor and the like and a periphery device controlling a gesture through the main CPU 71 are connected with the door PCB 90 and the body PCB 110. The control panel 30 and a cold-cathode tube 93 are connected to the door PCB 90.

An HELP switch 31S, a CASHOUT switch 32S, a BET switch 34S, an MAX BET switch 38S, a spin switch 46s corresponding to the above various buttons are disposed on the control panel 30. Various switches detect that corresponding buttons are pressed by a player and output a signal to the main CPU 71.

The cold-cathode tube 93 functions as a back light disposed on a back side of the upper image display panel 131, and the cold-cathode tube 93 is lighted according to a control signal output from the CPU 71.

The topper unit 14, the lamp 111, the speaker 112, the LED unit 117, a graphics board 130, the liquid crystal display device 134, the touch panel 115, the touch panel 114, an index detection circuit 151, a position change detection circuit 152, a back light control circuit 153 and a motor drive circuit 154 are connected onto the body PCB 110. In addition, the index detection circuit 151, the position change detection circuit 152, the back light control circuit 153 and the motor drive circuit 154 are connected to the reel unit M1.

The lamp 111 is lighted according to a control signal output from the main CPU 71. The speaker 112 outputs a sound such as the BGM and the like according to a control signal output from the main CPU 71.

The graphics board 130 controls an image display according to a control signal output from the main CPU 71, and the image display is performed by the upper image display panel 131. The above graphics board 130 includes a VDP (VIDEO DISPLAY PROCESSOR) generating an image data, a video RAM storing the image data generated by the VDP and the like. Further, an image data adopted when the VDP generates the image data is included within a game program, and the game program is read out from the SSD unit 55 and is stored in the RAM 73.

The liquid crystal display device 134 performs an image display according to a control signal output from the main CPU 71. The touch panel 115 detects a position touched by a finger and the like on the liquid crystal display device 134 and outputs a signal corresponding to the detected position to the main CPU 71. The touch panel 114 detects a position touched by a finger and the like on the upper image display device 131 and outputs a signal corresponding to the detected position to the main CPU 71.

The topper unit 14 performs an image display on the liquid crystal panel 141 according to a control signal output from the main CPU 71.

A stepper motor rotating the reels 101, 102 and 103 is connected onto the motor drive circuit 154. In addition, the motor drive circuit 154 includes an FPGA (FIELD PROGRAMMABLE GATE ARRY) and a driver. The FPGA is an electronic circuit such as a programmable LSI and the like and functions as a control circuit of the stepper motor. The driver functions as an amplifier circuit of a pulse input in the stepper motor.

The index detection circuit 151 is used to detect positions of the reels 101, 102 and 103 which are rotating, and the index detection circuit 151 can detect an out-of-step of the reels 101, 102 and 103.

The position change detection circuit 152 detects a change of stop positions of the reels 101, 102 and 103 after the reels 101, 102 and 103 stop rotating. For example, though a combination of symbols 501 is not associated to winning in actual, the position change detection circuit 152 detects a change of stop positions of the reels 101, 102 and 103, when the combination of symbols 501 is changed to be associated to winning due to a change of the stop positions resulted from external influences such as an improper manner and the like. For example, the position change detection circuit 152 is configured to be able to detect a change of stop positions of the reels 101, 102 and 103 by detecting fins (not shown) mounted on the internal side portions of the reels 101, 102 and 103 with a predetermined interval.

In addition, there is no particular limitation to the exciting mode of the stepper motor, and the stepper motor may adopt a 1-2 phases exciting mode or 2 phases exciting mode. Further, the stepper motor may be replaced with a DC motor. In the case of adopting a DC motor, an error counter, a D/A converter and a servo amplifier are connected onto the body PCB 110 successively, and the DC motor is connected with the servo amplifier. Further, a rotation position of the DC motor is detected by a rotary encoder, and a current rotation position of the DC motor is provided as a data from the rotary encoder to the error counter.

The back light control circuit 153 is connected with the back light unit to provide a drive power to the back light unit independently. Besides, the back light control circuit 153 may accept an instruction from the main CPU 71 to control the amount of light when an illuminated light emits, and thereby a multi-level change appears to the amount of light. In addition, three back light units disposed on internal surfaces of the reels 101, 102 and 103 may emit an illuminated light to nine symbols 501, which stop in the display window 150, through the back light control circuit 153. The back light control circuit 153 controls the back light unit, for example, which may not emit an illuminated light to symbols of “BONUS” during the procedure of performing a normal game but emit an illuminated light to the symbols of the “BONUS” during the procedure of performing a free game.

(Winning Combination)

Next, a winning combination of giving a payout in the slot machine 1 is illustrated.

(Winning Combination: a 3-Kind and an ANY BAR on the PAY LINE)

First, a winning combination coming into existence on the PAY LINE is illustrated. As mentioned above, it is winning when three symbols of a same kind of each of “TRIPLE NUTTY JACKPOT”, “DOUBLE NUTTY JACKPOT”, “RED7”, “3BAR”, “2BAR”, and “1BAR” are rearranged on the PAY LINE. The above symbol combination is termed as a 3-Kind sometimes in the following description. Besides, it is winning when three symbols of each of “3BAR”, “2BAR”, and “1BAR” are rearranged on the PAY LINE. The above symbol combination is termed as an ANY BAR sometimes in the following description. Further, the “TRIPLE NUTTY JACKPOT” and “DOUBLE NUTTY JACKPOT” function as wild symbols which may replace the “RED7”, “3BAR”, “2BAR”, and “1BAR”.

That is to say, symbols include normal symbols having “RED7”, “3BAR”, “2BAR” and “1BAR”; wild symbols having “TRIPLE NUTTY JACKPOT” and “DOUBLE NUTTY JACKPOT” which may replace the normal symbol; and a blank “BLANK” symbol.

In the present embodiment, each bet gives a payout of 2700 credits when a 3-Kind of the “TRIPLE NUTTY JACKPOT” comes into existence. In addition, each bet gives a payout of 800 credits when a 3-Kind of the “DOUBLE NUTTY JACKPOT” comes into existence. In addition, each bet gives a payout of 100 credits when a 3-Kind of the “RED7” comes into existence. In addition, each bet gives a payout of 40 credits when a 3-Kind of the “3BAR” comes into existence. In addition, each bet gives a payout of 20 credits when a 3-Kind of the “2BAR” comes into existence. In addition, each bet gives a payout of 10 credits when a 3-Kind of the “1BAR” comes into existence. In addition, each bet gives a payout of 5 credits when an ANY BAR comes into existence.

In addition, the above payout is triple when 3-Kind of normal symbols or ANY BAR including the “TRIPLE NUTTY JACKPOT” which is a wild symbol is established. That is to say, the “TRIPLE NUTTY JACKPOT” is a symbol which functions as the wild symbol and as a trigger changing the payout to be triple. Therefore, a payout becomes nonuple if two “TRIPLE NUTTY JACKPOT” are rearranged on the PAY LINE. In addition, the above payout is double when 3-Kind of the normal symbols or ANY BAR including the “DOUBLE NUTTY JACKPOT” which is a wild symbol is established. That is to say, the “DOUBLE NUTTY JACKPOT” is a symbol which functions as the wild symbol and as a trigger changing the payout to be double. Therefore, a payout becomes quadruple if two “DOUBLE NUTTY JACKPOT” are rearranged on the PAY LINE. As such, a wild symbol on the PAY LINE functions as a trigger which may multiply a payout by a predetermined value.

(Winning Combination: a Scattered Winning of Wild Symbol)

Except for the 3-Kind of the “TRIPLE NUTTY JACKPOT” and “DOUBLE NUTTY JACKPOT”, each bet gives a payout of 100 credits when the above three wild symbols are rearranged in the display window 150.

(Winning Combination: a Wild Symbol on the PAY LINE)

Symbols of the “TRIPLE NUTTY JACKPOT”, “DOUBLE NUTTY JACKPOT”, “RED7”, “3BAR”, “2BAR” and “1BAR” are configured to sandwich the “BLANK” symbol when provided into symbol columns of the reels 101, 102 and 103. Therefore, a normal symbol or a wild symbol is rearranged to an upper stage or a lower stage of the reels 101, 102 and 103 when the “BLANK” symbol is rearranged on the PAY LINE. Even if the wild symbol is rearranged to either of the upper stage or the lower stage of the above PAY LINE, the wild symbol also functions as a wild symbol which may replace a normal symbol configured on the PAY LINE.

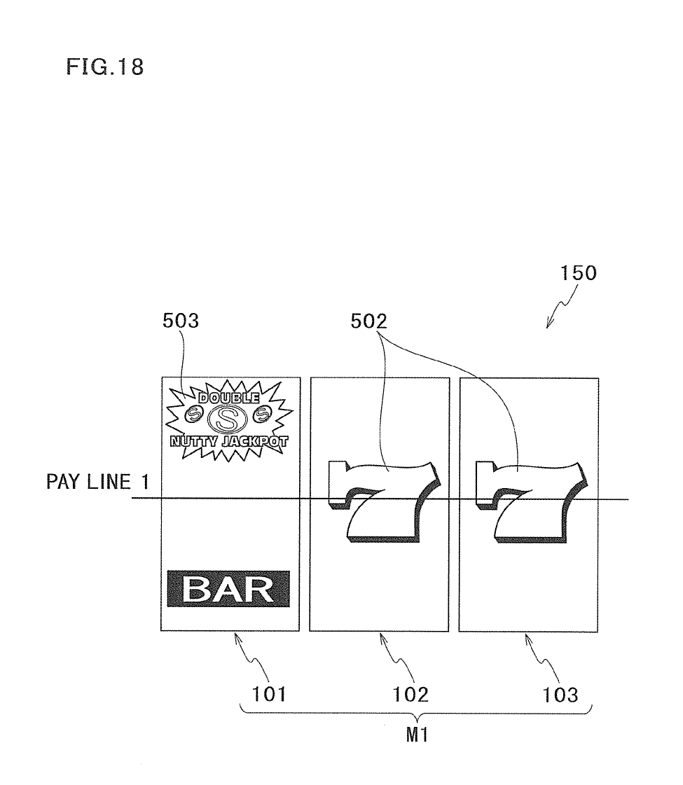

For example, as shown in the FIG. 18, a same kind of normal symbols 502 (RED7 symbol) are rearranged onto the PAY LINE of the reels 102 and 103, and a wild symbol 503 is rearranged to an upper stage of the PAY LINE of the reel 101, at the moment, a 3-Kind of the normal symbols rearranged on the PAY LINE of the reels 102 and 103 also comes into existence. However, the function of a wild symbol which is used to multiply a payout by a predetermined value (double or triple) is invalidated if the wild symbol is not rearranged onto the PAY LINE. As such, the slot machine 1 treats a wild symbol rearranged in a region except on the PAY LINE of the display window 150 as a symbol on the PAY LINE.

(Winning Combination: Progressive Payout)

A progressive payout is given when the wild symbol 503 is rearranged to the display window 150 in a predetermined state. The progressive payout is validated by the settings of the audit menu. In addition, the progressive payout is validated only when the bet of a player is an MAX bet. For the payout amount of the progressive payout, it is set to be five-level according to the state of the rearranged wild symbols 503 (TRIPLE NUTTY JACKPOT symbol 503A and DOUBLE NUTTY JACKPOT symbol 503B). In addition, in the audit menu, the five-levels are independently activated/inactivated, respectively. The details are illustrated in the below.

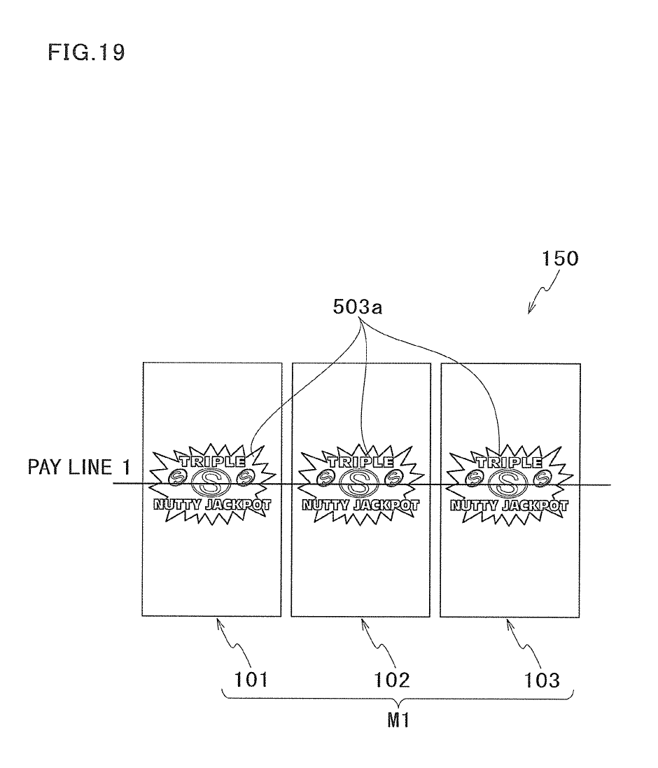

As shown in the FIG. 19, a first progressive payout of the most payout amount is given when three TRIPLE NUTTY JACKPOT symbols 503A are rearranged on the PAY LINE. The first progressive payout is a value obtained by multiplying 2700 credits by an MAX bet amount. The 3-Kind of the TRIPLE NUTTY JACKPOT symbols 503A also comes into existence simultaneously when the first progressive payout comes into existence. The actual payout may be a payout based on the 3-Kind added by the first progressive payout, and the actual payout may be also just the first progressive payout.

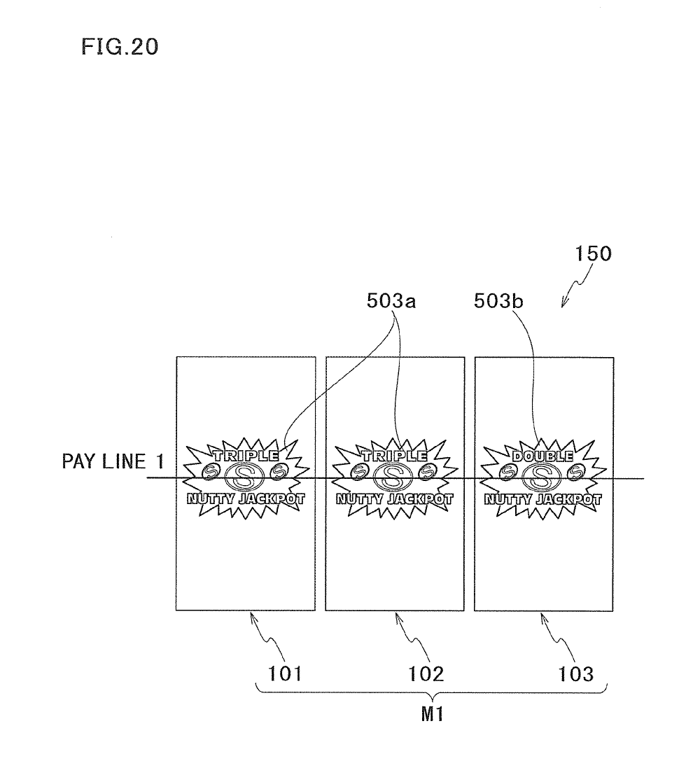

As shown in the FIG. 20, a second progressive payout of the second most payout amount is given, when two TRIPLE NUTTY JACKPOT symbols 503A are rearranged on the PAY LINE and one DOUBLE NUTTY JACKPOT symbol 503B is rearranged on the PAY LINE. The second progressive payout is a value obtained by multiplying 1800 credits by an MAX bet amount. The scattered winning of the wild symbols also comes into existence when the second progressive payout comes into existence. The actual payout may be a payout based on the scattered winning added by the second progressive payout, and the actual payout may be also just the second progressive payout.

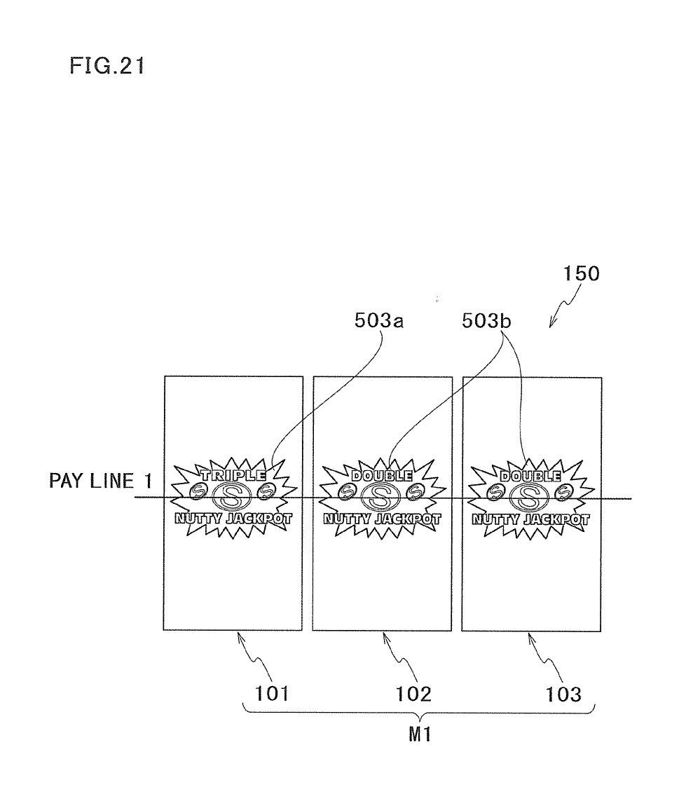

As shown in the FIG. 21, a third progressive payout of the third most payout amount is given, when one TRIPLE NUTTY JACKPOT symbol 503A is rearranged on the PAY LINE and two DOUBLE NUTTY JACKPOT symbols 503B are rearranged on the PAY LINE. The third progressive payout is a value obtained by multiplying 1200 credits by an MAX bet amount. The scattered winning of the wild symbol also comes into existence when the third progressive payout comes into existence. The actual payout may be a payout based on the scattered winning added by the third progressive payout, and the actual payout may be also just the third progressive payout.

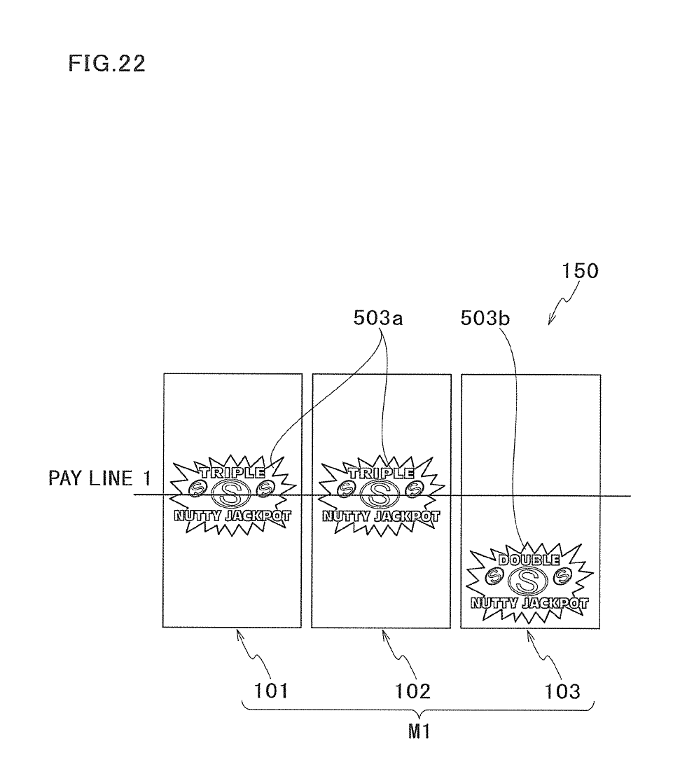

As shown in the FIG. 22, a fourth progressive payout of the fourth most payout amount is given, when two TRIPLE NUTTY JACKPOT symbols 503A are rearranged on the PAY LINE and each symbol of the wild symbols 503 is rearranged in a region except on the PAY LINE. The fourth progressive payout is a value obtained by multiplying 900 credits by an MAX bet amount. The scattered winning of the wild symbol also comes into existence when the fourth progressive payout comes into existence. The actual payout may be a payout based on the scattered winning added by the fourth progressive payout, and the actual payout may be also just the fourth progressive payout.

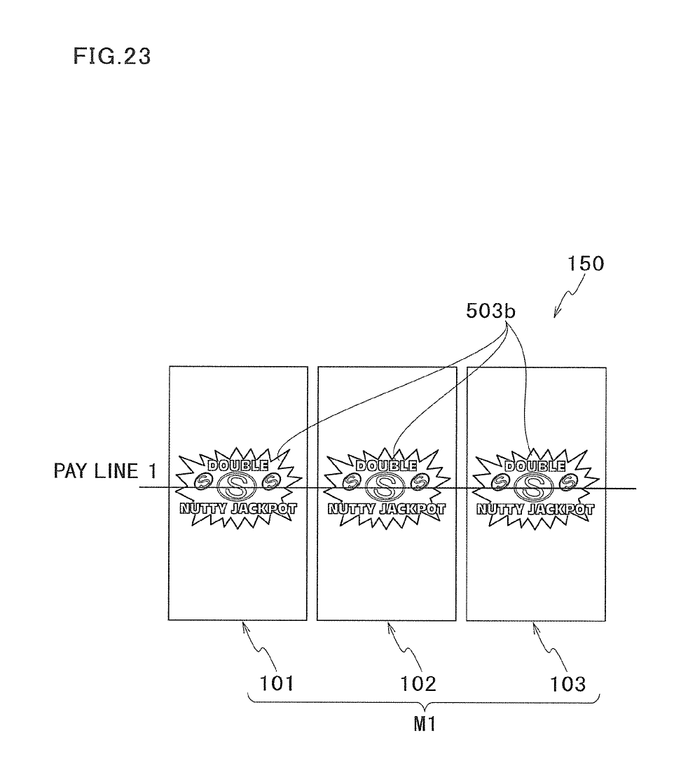

As shown in the FIG. 23, a fifth progressive payout of the least payout amount is given when three DOUBLE NUTTY JACKPOT symbols 503B are rearranged on the PAY LINE. The fifth progressive payout is a value obtained by multiplying 800 credits by an MAX bet amount. The 3-Kind of the DOUBLE NUTTY JACKPOT symbols 503B also comes into existence simultaneously when the fifth progressive payout comes into existence. The actual payout may be a payout based on the 3-Kind added by the fifth progressive payout, and the actual payout may be also just the fifth progressive payout.

(Payout: Bonus Payout)

A payout of the 3-Kind is added by a bonus payout when the 3-Kind of the TRIPLE NUTTY JACKPOT symbol 503A comes into existence in a game based on an MAX bet. It is set in the audit menu whether a bonus payout is added.

(Bet Arrangement Table)

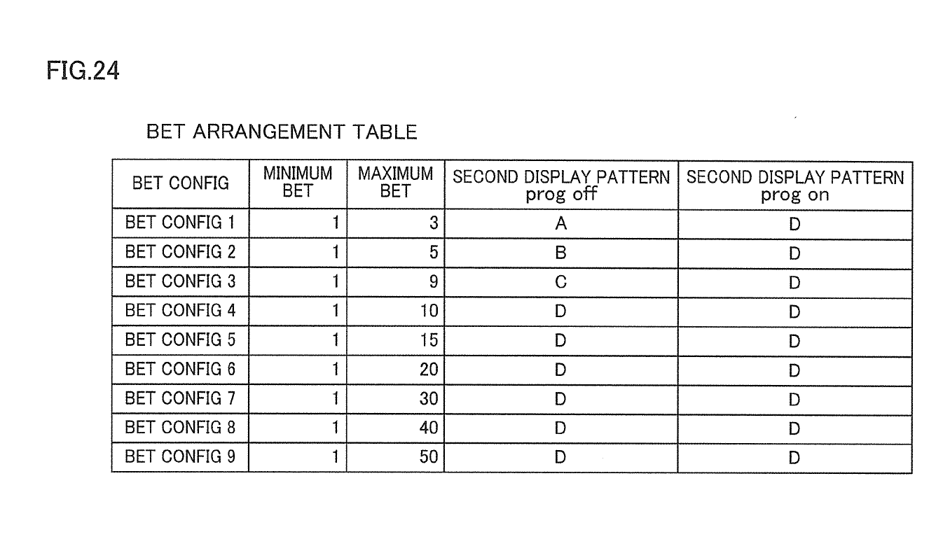

Next, refer to the FIG. 24, a bet arrangement table is illustrated. A payout table is displayed in the upper image display panel 131, and the payout table indicates a payout which may be obtained according to a bet amount. The above payout table has a plurality of display patterns according to a bet type in the audit menu and whether there is a progressive payout. The bet arrangement table is stored in a memory such as the SSD unit 55, the ROM 72, the RAM 73 and the like, wherein a plurality of display patterns displayed by the upper image display panel 131 correspond to the setting of the bet type (bet arrangement) of the audit.

As shown in the FIG. 24, nine kinds of bet types from BET CONFIG 1 to BET CONFIG 9 correspond to a smallest bet column, a greatest bet column, a display pattern when it is a progressive off and a display pattern field when it is a progressive on. The “progressive off” indicates that a bonus is set to be “null” in the audit and a progressive payout is not given. The “progressive on” indicates that a bonus is set to be “existence” in the audit and a progressive payout is given according to a condition.

Specifically, a smallest bet amount is “1” and a greatest bet amount is “3” if the “BET CONFIG 1” is set. If it is set to be the “BET CONFIG 1” and the progressive off, the display pattern of the upper image display panel 131 is “A”. If it is set to be the “BET CONFIG 1” and the progressive on, the display pattern of the upper image display panel 131 is “D”.

The smallest bet amount is “1” and the greatest bet amount is “5” if the “BET CONFIG 2” is set. If it is set to be the “BET CONFIG 2” and the progressive off, the display pattern of the upper image display panel 131 is “B”. If it is set to be the “BET CONFIG 2” and the progressive on, the display pattern of the upper image display panel 131 is “D”.

The smallest bet amount is “1” and the greatest bet amount is “9” if the “BET CONFIG 3” is set. If it is set to be the “BET CONFIG 3” and the progressive off, the display pattern of the upper image display panel 131 is “C”. If it is set to be the “BET CONFIG 3” and the progressive on, the display pattern of the upper image display panel 131 is “D”.

The smallest bet amount is “1” and the greatest bet amount is “10” if the “BET CONFIG 4” is set. The smallest bet amount is “1” and the greatest bet amount is “15” if the “BET CONFIG 5” is set. The smallest bet amount is “1” and the greatest bet amount is “20” if the “BET CONFIG 6” is set. The smallest bet amount is “1” and the greatest bet amount is “30” if the “BET CONFIG 7” is set. The smallest bet amount is “1” and the greatest bet amount is “40” if the “BET CONFIG 8” is set. The smallest bet amount is “1” and the greatest bet amount is “50” if the “BET CONFIG 9” is set. If it is set to be the “BET CONFIG 4” to the “BET CONFIG 9”, the display pattern of the upper image display panel 131 is “D” whether it is the progressive on or the progressive off.

(a Payout Table of the Upper Image Display Panel)

Next, various display patterns of the payout table in the upper image display panel 131 is illustrated concretely.

(A Payout Table of the Upper Image Display Panel: Display Pattern A)

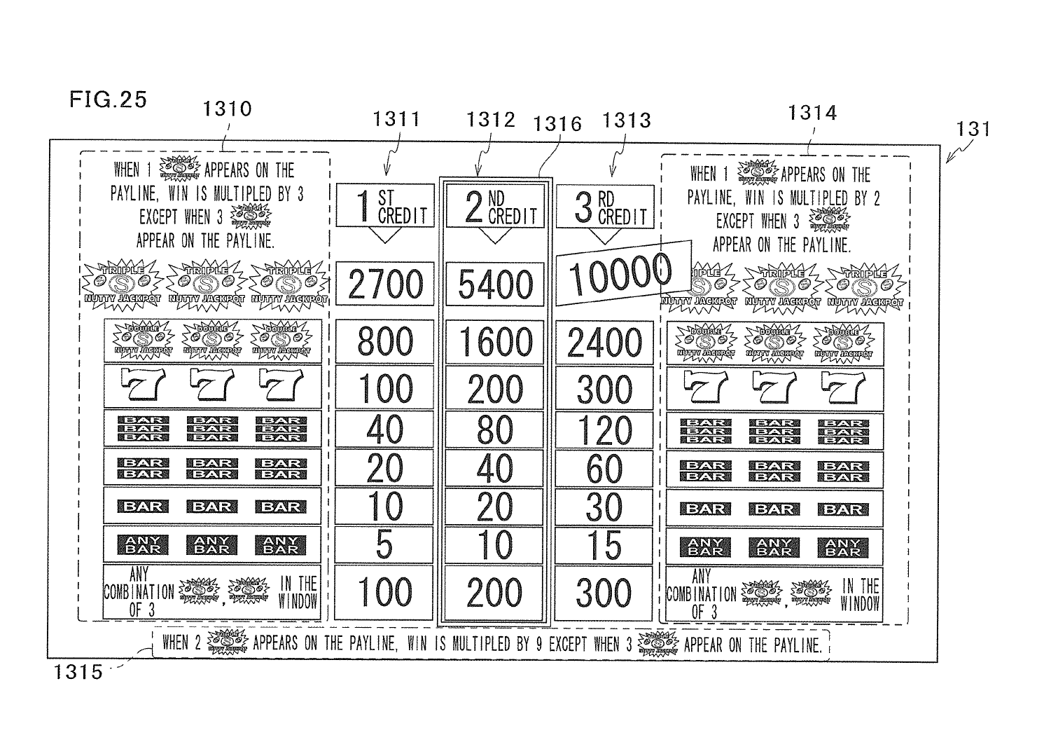

Refer to the FIG. 25, the display pattern A is illustrated, wherein the progressive payout is invalidated and the MAX bet is 3. A winning combination 1310, 1 bet payout table 1311, 2 bet payout table 1312 and 3 bet payout table 1313 at the left side and a winning combination 1314 and a sliding section 1315 at the right are displayed in the display pattern A.

The above winning combination is shown in the winning combination 1310 at the left side and the winning combination 1314 at the right side. That is to say, it is shown that a payout is given in the display window 150 when performing a rearrangement to symbols with which state.

A payout amount corresponding to each winning combination is shown in the 1 bet payout table 1311 when the bet amount is 1. A payout amount corresponding to each winning combination is shown in the 2 bet payout table 1312 when the bet amount is 2. A payout amount corresponding to each winning combination is shown in the 3 bet payout table 1313 when the bet amount is 3. That is to say, a value which is obtained by multiplying the payout amount per one bet by a bet amount is shown for each winning combination in the payout tables 1311-1313. In addition, a payout table corresponding to the current selected bet amount displays a frame image 1316 around the region of the payout table in the payout table 1311-1313. Thereby, the current selected bet amount by a player is shown. That is to say, the frame image 1316 moves towards right one by one whenever the BET button 34 is pressed.

In addition, as shown in the FIG. 25, a payout amount of the winning combination of the most payout in the 3 bet payout table 1313 is a value added by a bonus payout, when the bonus payout is validated. In the present invention, in the condition that the MAX bet is 3 bet, the payout amount is 10000 when the 3-Kind of the TRIPLE NUTTY JACKPOT symbol 503A comes into existence, and the value is shown in a corresponding position of the 3 bet payout table 1313. In the condition that the bonus payout is invalidated, the payout amount is 8100 when the 3-Kind of the TRIPLE NUTTY JACKPOT symbol 503A comes into existence, and the value is shown in a corresponding position of the 3 bet payout table 1313. A payout amount corresponding to a winning combination of the most payout is shown with a different state from others. For example, a payout amount corresponding to a winning combination of the most payout is shown obliquely, and the payout is shown with a bigger font.

The sliding section 1315 indicates the following content: a payout is changed to be nonuple when two TRIPLE NUTTY JACKPOT symbols 503A and one normal symbol are rearranged on the PAY LINE, the payout is changed to be quadruple when two DOUBLE NUTTY JACKPOT symbols 503B and one normal symbol are rearranged on the PAY LINE, and a wild symbol also functions as a wild when the wild symbol is rearranged in a region except on the PAY LINE. In the sliding section 1315, the above various information is displayed switchably with a predetermined time (for example, 10 seconds). An information displayed in the sliding section 1315 is displayed movably so that the information slides towards outside of the frame and the movable display is performed so that a next different information slides towards inside of the frame when the switchable display is performed. The sliding section 1315 also performs a same display in the condition of the display patterns B-D illustrated in the following description.

(A Payout Table of the Upper Image Display Panel: Display Pattern B)

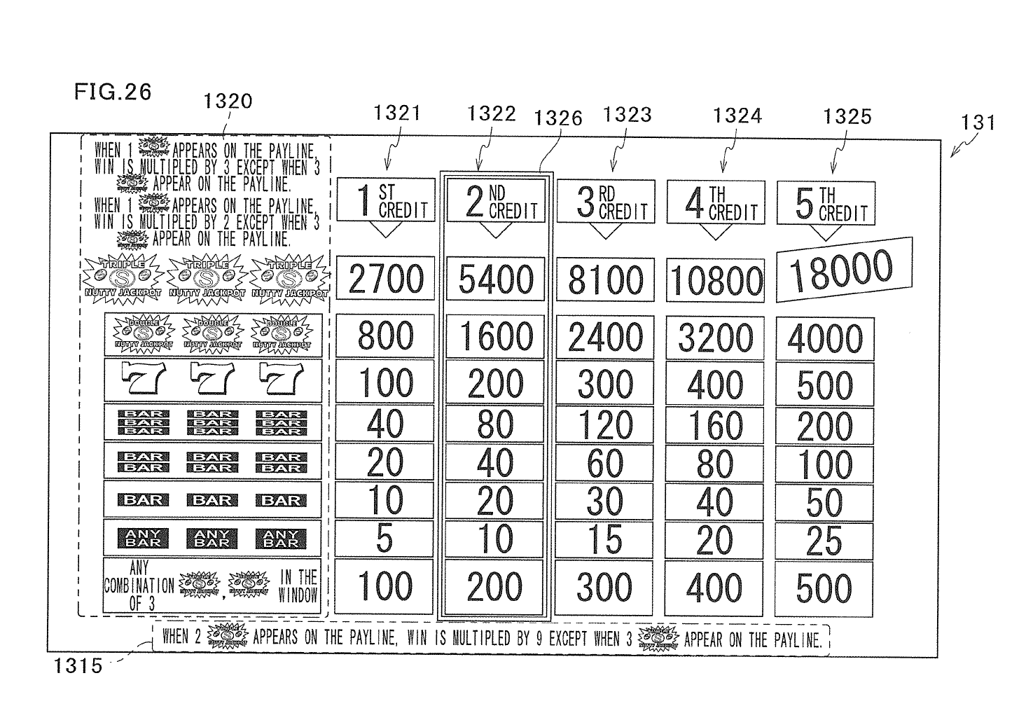

Refer to the FIG. 26, the display pattern B is illustrated, wherein the progressive payout is invalidated and the MAX bet is 5. A winning combination 1320, 1 bet payout table 1321, 2 bet payout table 1322, 3 bet payout table 1323, 4 bet payout table 1324, 5 bet payout table 1325 and the sliding section 1315 are displayed in the display pattern B.

The above winning combination is shown in the winning combination 1320. That is to say, it is shown that a payout is given in the display window 150 when performing a rearrangement to symbols with which state.

It is the same with the pattern A that a value which is obtained by multiplying the payout amount per one bet by a bet amount is shown for each winning combination in the payout tables 1321-1325. A payout table corresponding to the current selected bet amount displays a frame image 1326 around the region of the payout table in the payout table 1321-1325. That is to say, the frame image 1326 moves towards right one by one whenever the BET button 34 is pressed.

In addition, as shown in FIG. 26, a payout amount of the winning combination of the most payout in the 5 bet payout table 1325 is a value added by a bonus payout, when the bonus payout is validated. In the present invention, in the condition that the MAX bet is 5 bet, the payout amount is 18000 when the 3-Kind of the TRIPLE NUTTY JACKPOT symbol 503A comes into existence, and the value is shown in a corresponding position of the 5 bet payout table 1325. In the condition that the bonus payout is invalidated, the payout amount is 13500 when the 3-Kind of the TRIPLE NUTTY JACKPOT symbol 503A comes into existence, and the value is shown in a corresponding position of the 5 bet payout table 1325. A payout amount corresponding to a winning combination of the most payout is shown with a different state from others. For example, a payout amount corresponding to a winning combination of the most payout is shown obliquely, and the payout is shown with a bigger font.

(A Payout Table of the Upper Image Display Panel: Display Pattern C)

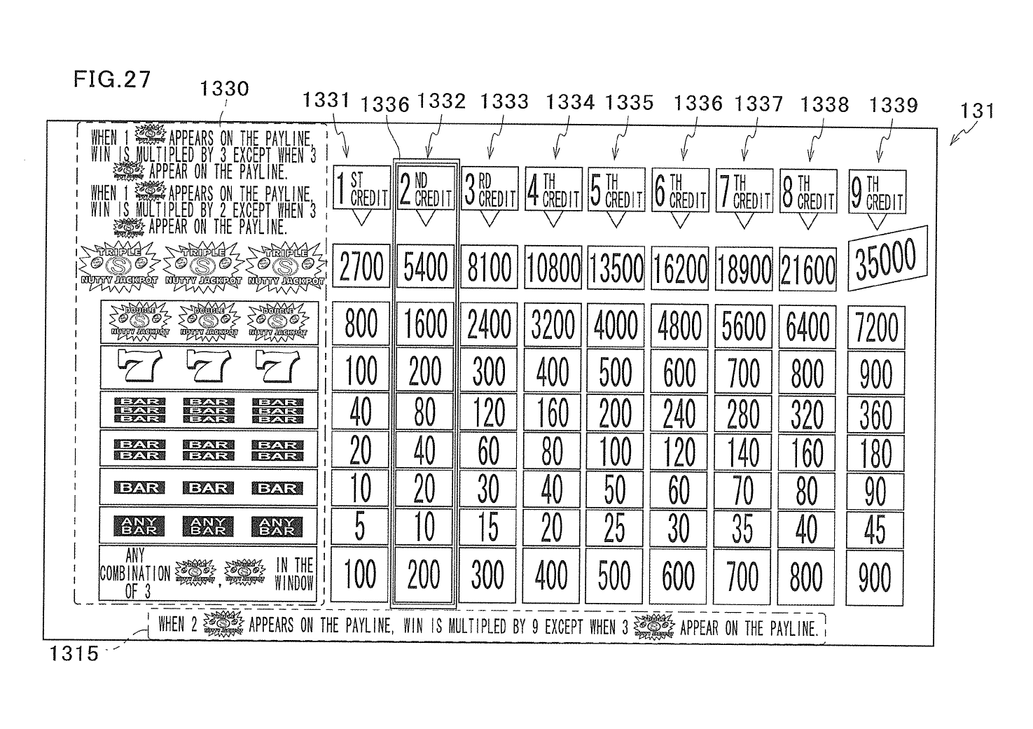

Refer to the FIG. 27, the display pattern C is illustrated, wherein the progressive payout is invalidated and the MAX bet is 9. A winning combination 1330, 1 bet payout table 1331, 2 bet payout table 1332, 3 bet payout table 1333, 4 bet payout table 1334, 5 bet payout table 1335, 6 bet payout table 1336, 7 bet payout table 1337, 8 bet payout table 1338, 9 bet payout table 1339 and the sliding section 1315 are displayed in the display pattern C.

The above winning combination is shown in the winning combination 1330. That is to say, it is shown that a payout is given in the display window 150 when performing a rearrangement to symbols with which state.

It is the same with the pattern A and pattern B that a value which is obtained by multiplying the payout amount per one bet by a bet amount is shown for each winning combination in the payout tables 1331-1339. A payout table corresponding to the current selected bet amount displays a frame image 1336 around the region of the payout table in the payout table 1331-1339. That is to say, the frame image 1336 moves towards right one by one whenever the BET button 34 is pressed.

In addition, as shown in FIG. 27, a payout amount of the winning combination of the most payout in the 9 bet payout table 1339 is a value added by a bonus payout, when the bonus payout is validated. In the present invention, in the condition that the MAX bet is 9 bet, the payout amount is 35000 when the 3-Kind of the TRIPLE NUTTY JACKPOT symbol 503A comes into existence, and the value is shown in a corresponding position of the 9 bet payout table 1339. In the condition that the bonus payout is invalidated, the payout amount is 24300 when the 3-Kind of the TRIPLE NUTTY JACKPOT symbol 503A comes into existence, and the value is shown in a corresponding position of the 9 bet payout table 1339. A payout amount corresponding to a winning combination of the most payout is shown with a different state from others. For example, a payout amount corresponding to a winning combination of the most payout is shown obliquely, and the payout is shown with a bigger font.

(A Payout Table of the Upper Image Display Panel: Display Pattern D)

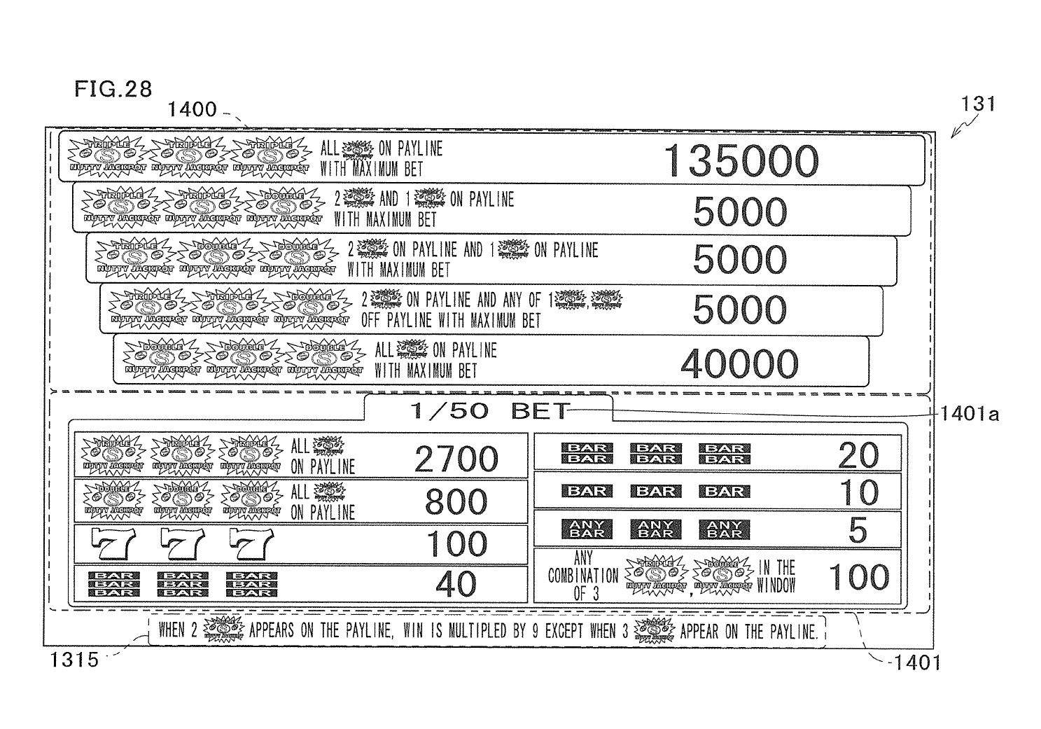

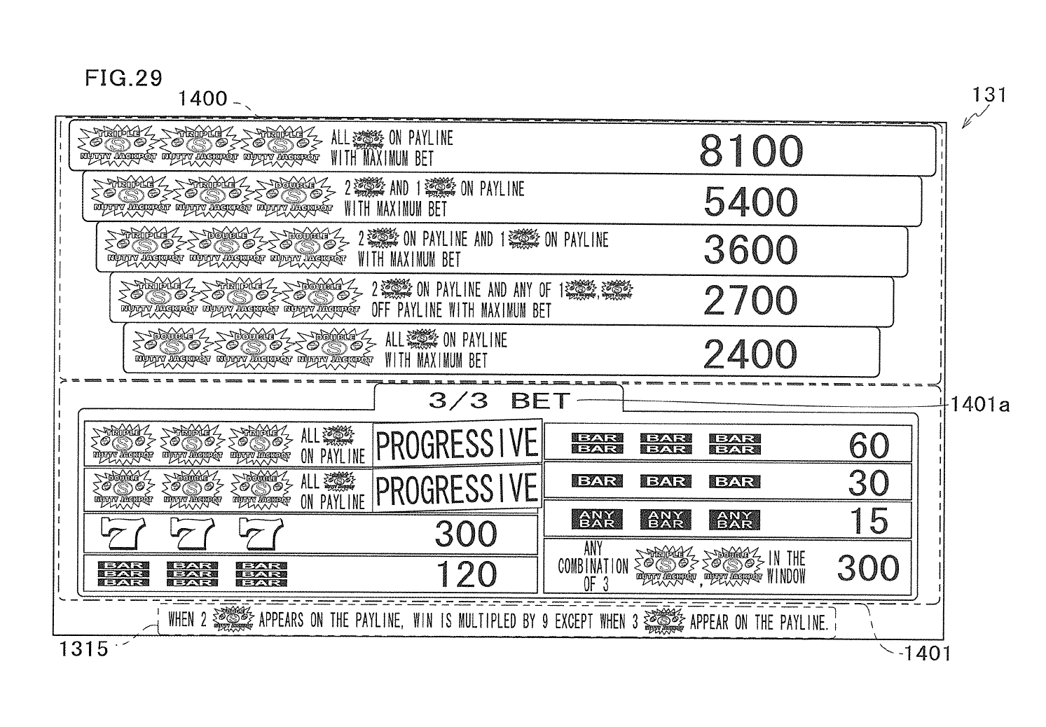

Refer to the FIG. 28 and the FIG. 29, the display pattern D is illustrated. The display pattern D is displayed when the progressive payout is invalidated and the MAX bet is 10, 15, 20, 30, 40 and 50.In addition, the display pattern D is displayed when the progressive payout is validated.

As shown in the FIG. 28 and the FIG. 29, an MAX bet payout table 1400, a selection bet payout table 1401 and the sliding section 1315 are shown in the display pattern D. It indicates a payout which may be given when symbols are rearranged with the state of the 1st-5th progressive payout in the MAX bet payout table 1400. A payout corresponding to the current selected bet amount is shown for each winning combination in the selection bet payout table 1401. Therefore, a payout displayed in the selection bet payout table 1401 changes whenever the bet amount changes. In addition, it is under the state that the bet amount is 1 when the slot machine 1 starts, and thus a payout corresponding to the bet amount 1 is displayed in the selection bet payout table 1401. Further, the selection bet payout table 1401 includes a selection bet display portion 1401A at the upper portion. The current bet amount and MAX bet amount are displayed with a state of “current selected bet amount/MAX bet amount” in the selection bet display portion 1401A.

(A Payout Table of the Upper Image Display Panel: Display Pattern D When the Progressive Payout is Invalidated)

Specifically, as shown in the FIG. 28, a payout when it is the MAX bet is displayed in the MAX bet payout table 1400, when the progressive payout is invalidated and the MAX bet is more than 10.

Since the progressive payout is invalidated, a following value is displayed at a corresponding position of the first progressive payout, and that is a value which is obtained by multiplying a payout amount of each bet by the MAX bet amount when the 3-Kind of the TRIPLE NUTTY JACKPOT symbol 503A comes into existence. In addition, it is a value which is added by a bonus payout when the bonus payout is validated.

A following value is displayed at a corresponding position of the 2nd-4th progressive payout of the MAX bet payout table 1400, and that is a value which is obtained by multiplying a payout amount of each bet by the MAX bet amount when the scattered winning of the wild symbol comes into existence. A following value is displayed at a corresponding position of the 5th progressive payout of the MAX bet payout table 1400, and that is a value which is obtained by multiplying a payout amount of each bet by the MAX bet amount when the 3-Kind of the DOUBLE NUTTY JACKPOT symbol 503B comes into existence.

(A Payout Table of the Upper Image Display Panel: Display Pattern D When the Progressive Payout is Validated)

As shown in the FIG. 29, a progressive payout is displayed in the MAX bet payout table 1400 when a rearrangement is performed to symbols with a state of the 1st-5th progressive payout, when the progressive payout is validated. For the payout shown in the MAX bet payout table 1400, it may indicates a value which is obtained by adding a payout based on the 3-Kind or the scattered winning to a progressive payout, and it may also only indicates the progressive payout.

In addition, as shown in the FIG. 29, if a player selects the MAX bet, a “PROGRESSIVE” character may be displayed to replace the payout amount at a position corresponding to the progressive payout of the selection bet payout table 1401. The “PROGRESSIVE” character is shown obliquely and is shown with a bigger font than other payout amount.

(A Payout Table of the Upper Image Display Panel: Effect)

Next, an effect of the payout table of the upper image display panel 131 and an effect which is associated to the payout are illustrated.

One display pattern is selected from the display patterns A-D and the display pattern is displayed in the upper image display panel 131 according to the validated setting/invalidated setting of the progressive payout and the setting of the MAX bet amount, when the slot machine 1 starts with a state that the memory is reset. The frame images 1316, 1326 and 1336 display various payout tables with a state of non-display in the upper image display panel 131, when the display patterns A-C are selected (refer to the FIG. 25, FIG. 26 and FIG. 27). The credit amount displayed in the selection bet payout table 1401 is shown with a value of the bet amount corresponding to 1, when the display pattern D is selected (refer to the FIG. 28).

In the display patterns A-C, when a bet amount is changed by a player, the bet amount is displayed under the condition that the frame images 1316, 1326 and 1336 are not displayed, and a payout corresponding to the selected bet is displayed in a highlighted manner. In addition, the frame images 1316, 1326 and 1336 move to a position corresponding to the selected bet amount when the bet amount is changed by a player. In the display pattern D, the credit amount displayed in the selection bet payout table 1401 changes when the bet amount is changed by a player. The above highlighted display and the credit display are kept until a player changes the bet amount. A game starts with a selected bet amount when the spin button 46 is pressed by a player. The reels 101, 102 and 103 rotate when the game starts, and then stop rotating, and it judges whether it is winning.

If it is not winning, the above highlighted display and the credit display are kept and entering an idle state, and it becomes a state in which a next game may start.

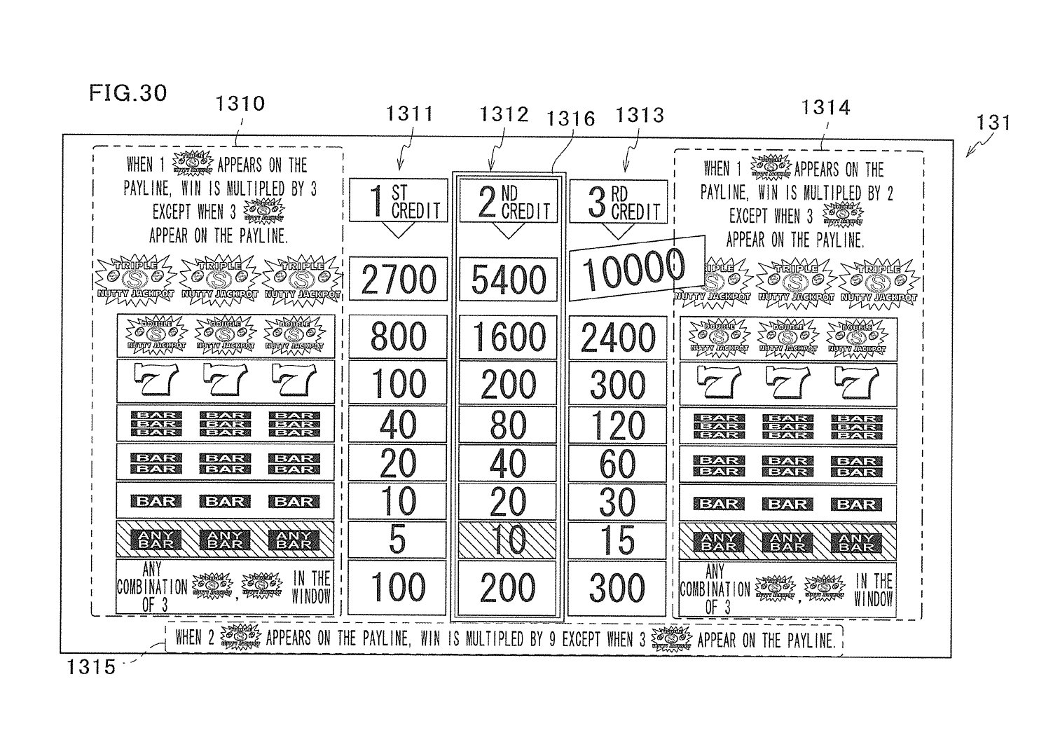

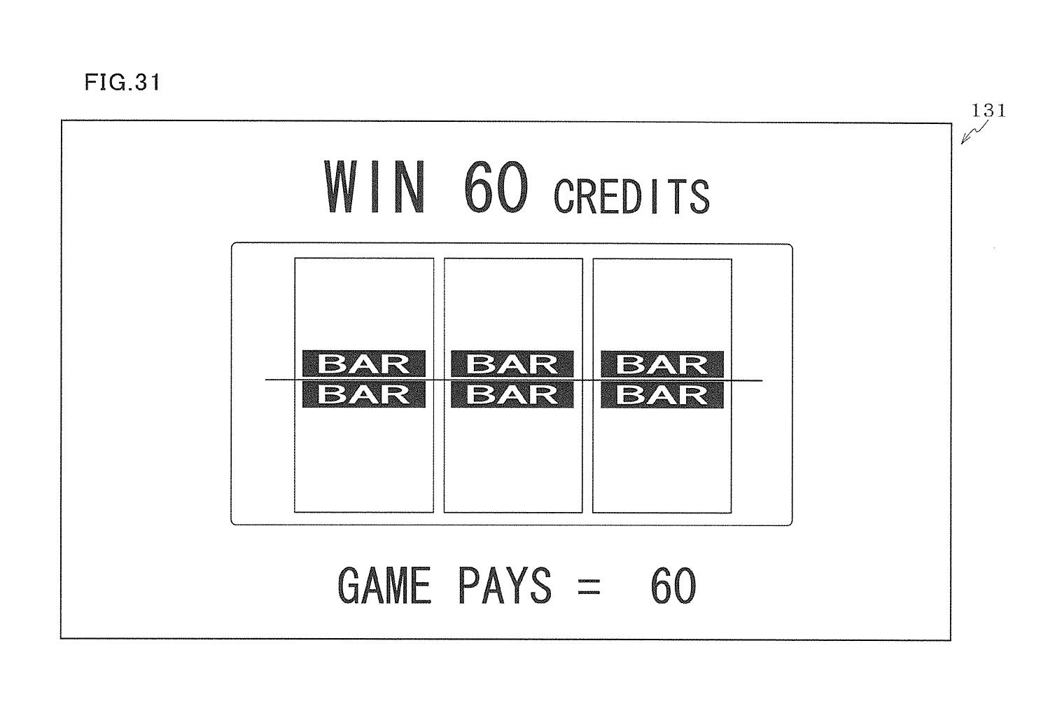

As shown in the FIG. 30 and the FIG. 31, if a winning is determined and the winning belongs to be a winning without a progressive payout, the effects of the payout tables of the upper image display panel are different due to the difference of the settings of the “graphics” in the audit menu.

As shown in the FIG. 30, a region of a winning combination related to the winning is displayed sparklingly in the payout table of the upper image display panel 131, when a setting item of “WIN GRAPHIC TYPE” is set to be “BASIC”. Specifically, a grayout display and a normal display (refer to the FIG. 25) of the region of the winning combination related to the winning are displayed exchangeably and repeatably. In addition, luminous mode of the back light of the symbols related to the winning is a sparking display in the reels 101, 102 and 103, when the setting item of the “SYMBOL LED TYPE” of LED is set to be “BASIC”.

In addition, as shown in the FIG. 31, the payout table of the upper image display panel 131 changes to be non-display and a winning combination related to the winning and a payout credit based on the winning are displayed, when the setting item of “WIN GRAPHIC TYPE” is set to be “ADVANCE”. For the payout credit, an increment display increasing from 1 to the payout amount is performed. In addition, luminous mode of the back light of the symbols related to the winning is a gradation display in the reels 101, 102 and 103, when the setting item of the “SYMBOL LED TYPE” of LED is set to be “ADVANCE”.

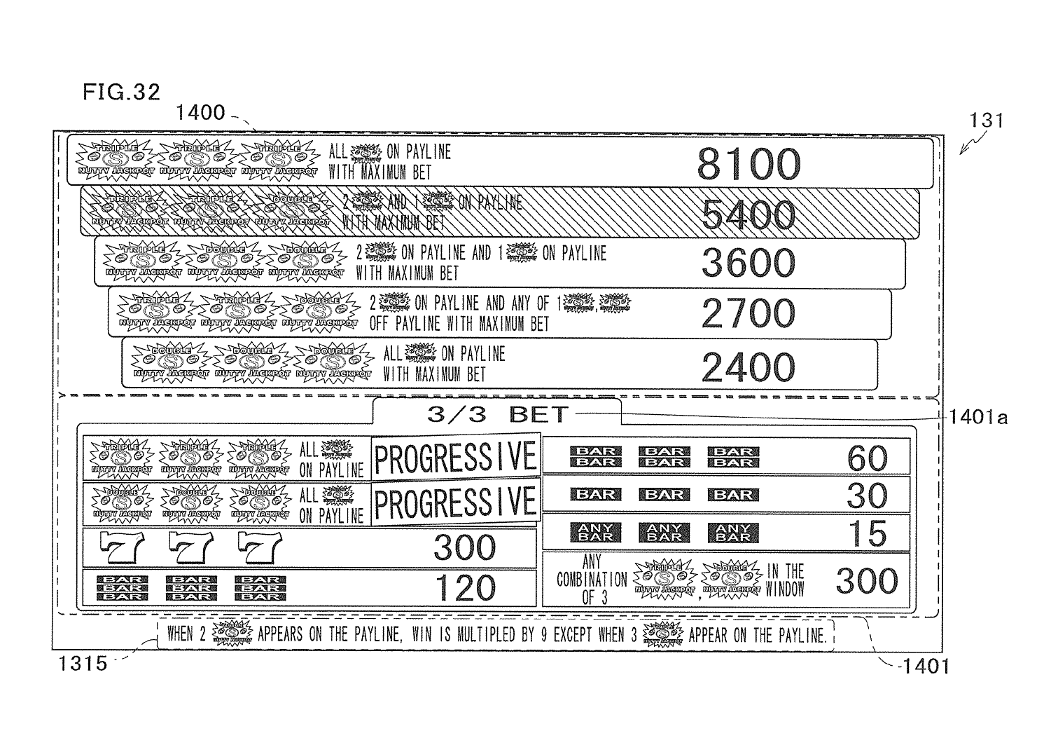

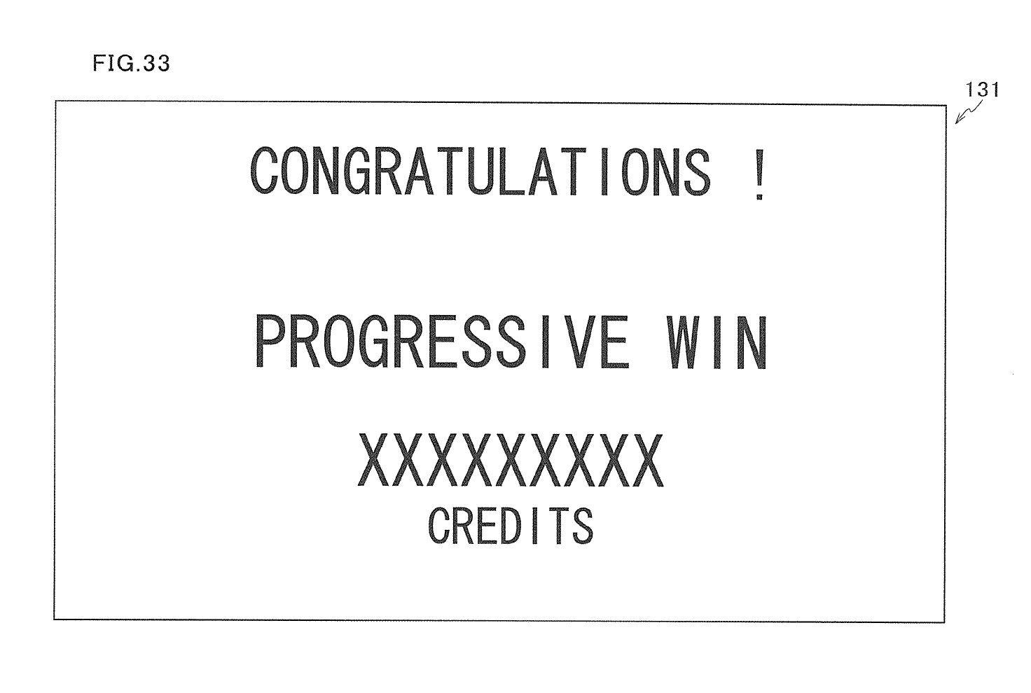

As shown in the FIG. 32 and the FIG. 33, if it is determined that there is a progressive payout, the effects of the payout tables of the upper image display panel are different due to the difference of the settings of the “graphics” in the audit menu.

As shown in the FIG. 32, the region where a progressive payout is given is displayed sparklingly in the payout table of the upper image display panel 131, when the setting item of “WIN GRAPHIC TYPE” is set to be “BASIC”. Specifically, a grayout display and a normal display (refer to the FIG. 28) of the region of the winning combination related to the winning are displayed exchangeably and repeatably.

In addition, as shown in the FIG. 33, the payout table of the upper image display panel 131 changes to be non-display and a payout credit which is obtained based on a progressive payout is displayed, when the setting item of “WIN GRAPHIC TYPE” is set to be “ADVANCE”. The payout credit is displayed with maximum bits of 12 characters. In addition, luminous mode of the back light of the symbols related to the progressive payout performs a gradation display in the reels 101, 102 and 103, when the setting item of the “SYMBOL LED TYPE” of LED is set to be “ADVANCE”. Further, an increment display is performed to the payout credit.

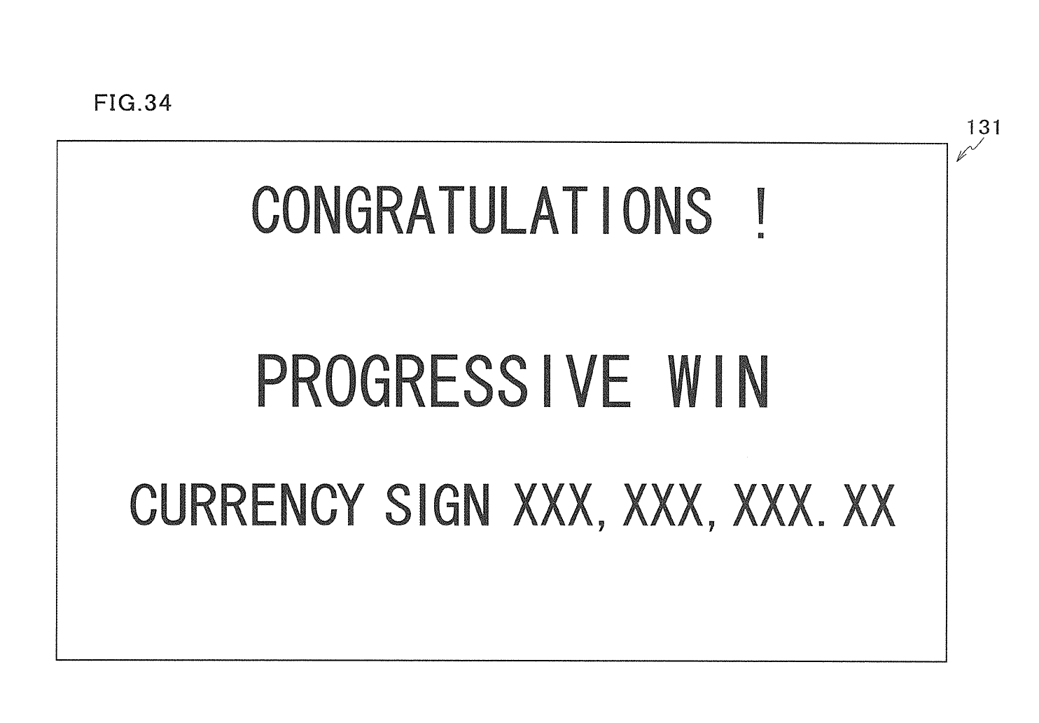

As shown in the FIG. 34, a payout amount may be displayed as the actual amount if it is determined that there is a progressive payout. That is to say, in the upper image display panel 131, a value which is obtained by multiplying a payout credit amount to be given by an amount set to 1 bet may indicate a currency sign. For example, the currency sign is shown as US Dollar, Hong Kong Dollar, Philippines Dollar and other signs. The payout amount is displayed with maximum bits of 16 characters (including a currency sign). Further, an increment display is performed to the payout amount. In addition, if the bits of a character including a currency sign is less than 10, a font used when the bits is less than 10 is adopted, when an increment display is performed to the payout amount displayed in the upper image display panel 131. In addition, if the bits of a character including a currency sign is more than 10, a font used when the bits is more than 10 is adopted, when an increment display is performed to the payout amount displayed in the upper image display panel 131.

Each credit displays for 0.1 second and meanwhile the number increases when the increment display is performed. Further, the increment display may be skipped according to the operation in the control panel 30.

A sound effect is output while the above increment displayed is performed. The sound effect may be set to be different sound according to a winning combination of the winning and the progressive payout. For example, different sound effects may be adopted in the following conditions, that are, a winning related to the 3-Kind of “3BAR”, “2BAR” and “1BAR” or the ANY BAR, a winning related to the 3-Kind of “RED7”, a winning related to the 3-Kind of “TRIPLE NUTTY JACKPOT” and “DOUBLE NUTTY JACKPOT”, a winning including a progressive payout, and the like. In addition, a threshold value may be set for the payout amount and different sound effects are adopted according to the different payout amounts. In addition, a threshold value may be set for a ratio of the payout to the bet, and different sound effects are adopted according to the different ratios of payout amounts to bets.

(Liquid Crystal Display Device 134)

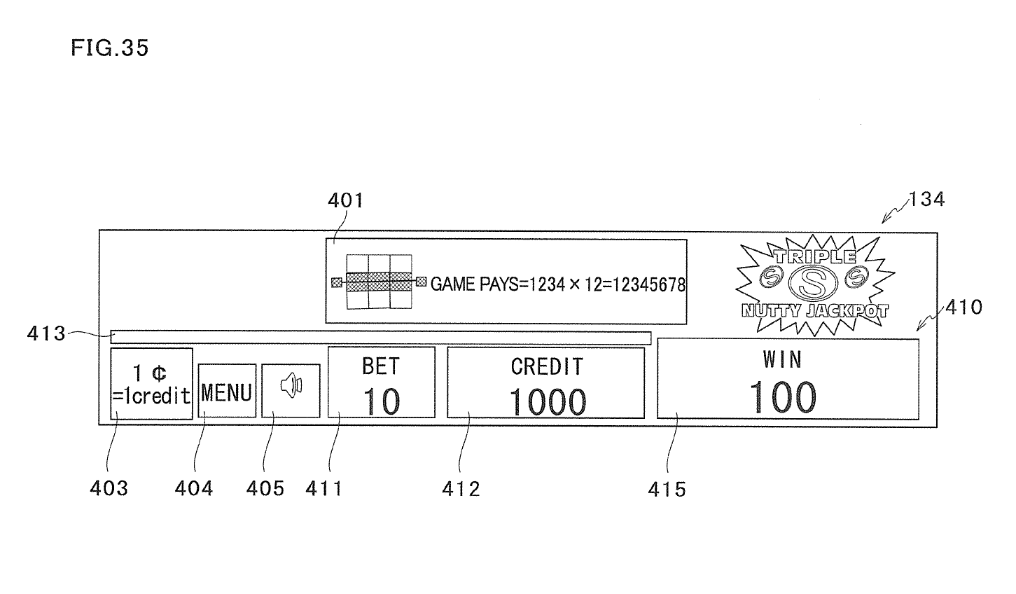

Next, refer to the FIG. 35, a screen displayed by the liquid crystal display device 134 during the procedure of the above process is illustrated. As shown in the FIG. 35, positions in which the symbols associated to a winning are configured are displayed in a game message area 401 of the liquid crystal display device 134. Specifically, a square of three rows and three columns of the display window 150 is displayed in the game message area 401, and the PAY LINE is displayed in a square corresponding to a middle stage of each of the reels. Also, a square corresponding to the stop positions of the symbols related to a winning is displayed in a highlighted manner. For example, in the condition that there is a progressive payout, a square corresponding to the stop positions of the wild symbols is displayed in a highlighted manner. As mentioned above, positions of the symbols related to a winning are only displayed but the kinds of the symbols are not displayed.

In addition, a total payout amount to be given is displayed at the right of the above squares. Further, there is no limitation to the representation state of the total payout amount, it may be as “GAME PAYS=12345678” to only display the sum, may be also as “GAME PAYS 1234×12=12345678” to display a payout amount per one bet, the bet amount and the sum. In addition, in the condition that there is a progressive payout, a payout amount which is obtained based on the progressive payout is displayed as “PROGRESSIVE WIN=12345678901”.

(Program Content)

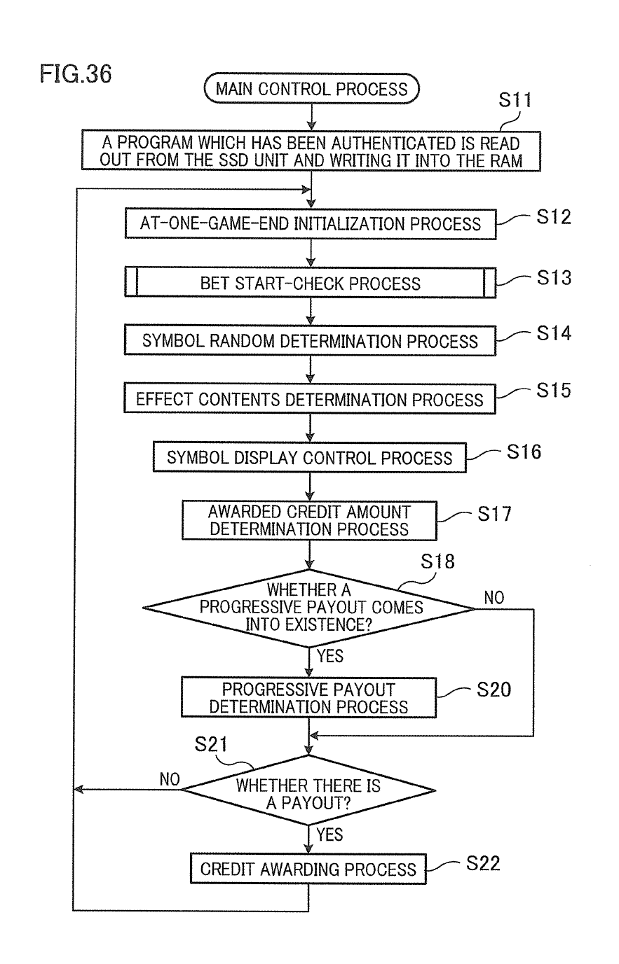

Next, refer to the FIGS. 36-38, a program executed by the slot machine 1 is illustrated.

(Main Control Process)

First, refer to the FIG. 36, the main control process is illustrated. First, the main CPU 71 reads a game program which has been certificated from the SSD unit 55 through the gaming board 50, and the game program is written into the RAM 73, when the slot machine 1 is power-on (S11). In addition, a setting content modified by the audit menu herein is also written into the RAM 73. That is to say, the slot machine 1 needs to restart under the condition that the setting is modified by the audit menu. Then, for example, the slot machine 1 selects a display pattern of the payout table and displays the display pattern into the upper image display panel 131 according to the game program written into the RAM 73.

Next, the main CPU 71 executes an initial process when a game ends. For example, a reset is performed to the data (for example, a symbol determined by a bet amount and a random determination, and the like) which is not required by each game in the working region of the RAM 73.

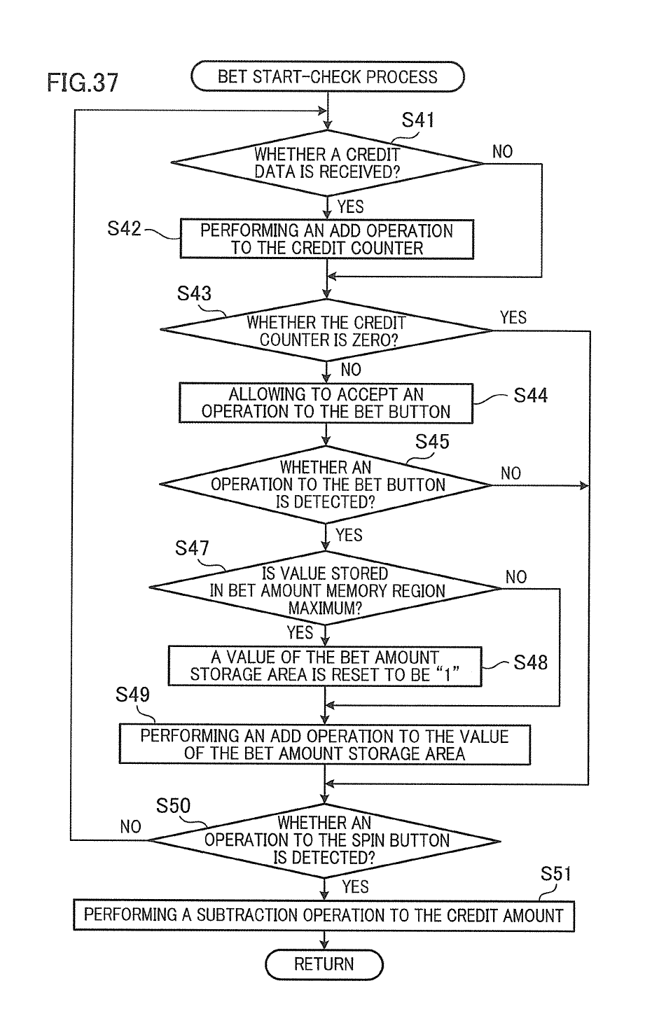

Next, the main CPU 71 executes a bet/start check process illustrated with reference to the FIG. 37 below (S13). In this process, an input check such as a BET SWITCH 34S, an MAX BET SWITCH 38S, a spin switch 46S and the like is performed.

Next, the main CPU 71 executes a symbol random determination process (S14). In this process, a to-be-stopped symbol is determined according to a symbol determination-use random number. In the present embodiment, the to-be-stopped symbols are determined for the reels 101-103 and by a random determination, according to a weight relative to the symbol corresponding to a code number shown in the symbol table which is not shown.

Next, the main CPU 71 executes an effect content determination process (S15). The main CPU 71 extracts out an effect-use random number, and one is determined from a plurality of effect contents which are set in advance by a random determination. The setting contents which are set for the setting items of various effects are referred, when the effects are determined, wherein the setting items of various effects are set through the audit menu.

Next, the main CPU 71 executes a symbol representation control process (S16). In this process, the reels 101-103 start to scroll, and the to-be-stopped symbol which is determined in the symbol random determination process of S14 stops at a predetermined position (for example, at the middle stage region of the display window 150). That is to say, nine symbols including the to-be-stopped symbol are displayed in the display window 150. In addition, an effect which is determined by the effect content determination process of S15 is executed when the above symbol representation control process is executed.

Next, the main CPU 71 executes an awarded credit amount determination process (S17). In this process, refer to the payout table stored in the RAM 73, an awarded credit amount based on the line winning or the scattered winning is determined, and the awarded credit amount is stored in an awarded credit amount memory region disposed in the RAM 73.

Next, the main CPU 71 judges whether a progressive payout has come into existence (S18). In the present embodiment, it is determined to give a progressive payout, when the wild symbol 503 is rearranged in the display window 150 with the state shown as the FIG. 19 to the FIG. 23. A progressive payout determination process is executed (S20), when the main CPU 71 judges that the progressive payout has come into existence (S18: YES).

Next, the main CPU 71 judges whether there is a payout (S21), after the process of S20 or when it is judged that the progressive payout has not come into existence in S18 (S18: NO). That is to say, it is judged whether a payout is given in the process of S17 and S20. Thereafter, a process of giving a credit is executed (S22) if it is judged that there is a payout (S21: YES). The main CPU 71 adds a value stored in the awarded credit amount memory region to a value stored in a credit amount memory region which is disposed in the RAM 73. In addition, the main CPU 71 controls the PTS unit 700 according to the input to the CASHOUT switch 32S which is written into an IC card as a credit data used to represent the value stored in the awarded credit amount memory region, and the IC card is inserted in an insert card slot. Further, an effect is performed according to the setting items of various effects and whether there is a progressive payout in the process of giving a credit. Return to S12 after the above process is performed or when it is judged that there is not a payout in the process of S21 (S21: NO).

(Bet/Start Check Process)

Next, refer to the FIG. 37, a bet/start check process is illustrated.

First, the main CPU 71 judges whether a credit data is received from the PTS unit 700 (S41). In addition, a credit data is sent to the main CPU 71 by the PTS unit 700 when an IC card is inserted into the insert card slot and when the bill entry 60 accepts a bill of genuine.

The amount represented by the received credit data is added to a value stored in the credit amount memory region (S42), when the main CPU 71 judges that the credit data is received (S41: YES).

The main CPU 71 judges whether the value stored in the credit amount memory region is zero (S43), after S42 or when it is judged that the credit data is not received in S41 (S41: NO). The main CPU 71 allows to accept the operations of the BET button 34, the MAX and the BET button 38 (S44), when it is judged that the value stored in the credit amount memory region is not zero (S43: NO).

Next, the main CPU 71 judges whether the operation of the BET button 34 is detected (S45). It is judged whether a value stored in the BET AMOUNT memory region is a maximum value (S47), when the main CPU 71 detects that the BET button 34 is pressed by a player (S45: YES). The main CPU 71 resets the value which is stored in the BET AMOUNT memory region to be 1 (S48), when it is judged that the value stored in the BET AMOUNT memory region is the maximum value (S47: YES).

The main CPU 71 adds one to the value which is stored in the BET AMOUNT memory region disposed in the RAM 73 (update) (S46), after S48 or when it is judged that the value which is stored in the BET AMOUNT memory region is not the maximum value in S47 (S47: NO). In addition, the main CPU 71 changes the payout table in the upper image display panel 131 whenever the BET SWITCH 34S detects the button press. Specifically, the main CPU 71 displays the frame images 1316, 1326 and 1336 at the positions corresponding to the BET AMOUNT which is currently selected, under the condition that the patterns A-C are displayed. In addition, the main CPU 71 displays the credit corresponding to the BET AMOUNT which is currently selected in the payout table, under the condition that the patterns D is displayed.

The main CPU 71 judges whether an operation to the spin button 46 is detected (S50), after S49 or when it is judged that an operation to the BET button is not detected in S45 (S45:NO), or when it is judged that a value stored in the credit amount memory region is zero in S43 (S43:YES). The main CPU 71 returns to S41 when it is judged that an operation to the spin button 46 is not detected (S50:NO).

On the other hand, the main CPU 71 subtracts a value stored in the BET AMOUNT memory region from a value stored in the credit amount memory region (S51), when it is judged that an operation to the spin button 46 is detected (S50:YES). Then, the bet/start check process ends.

(Effect Setting Process)

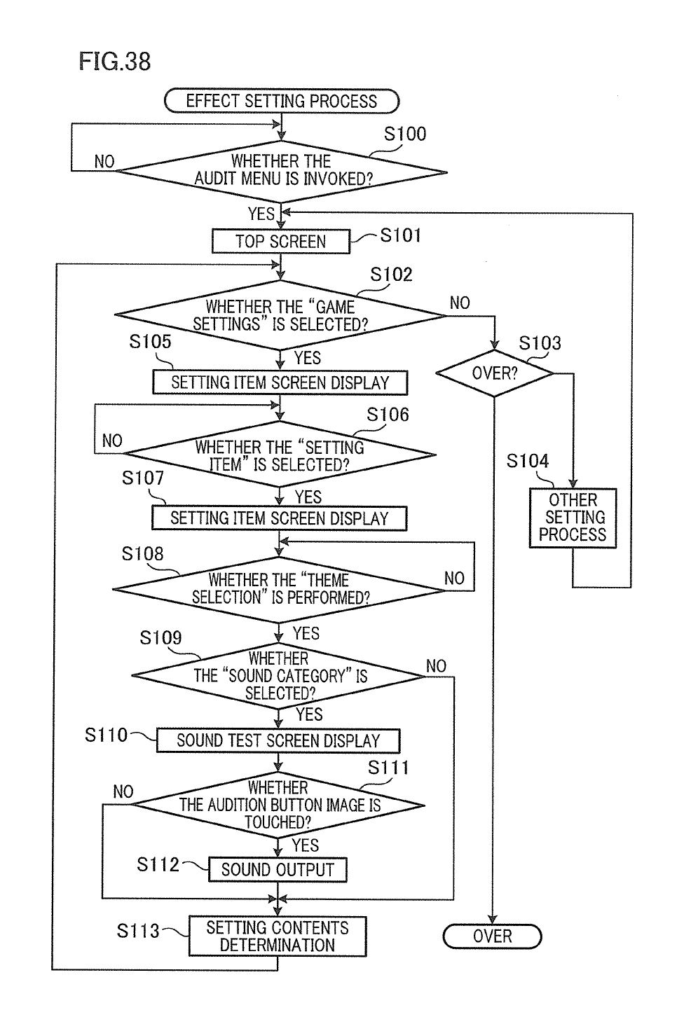

Next, refer to the FIG. 38, an effect setting process is illustrated.

First, the main CPU 71 judges whether an AUDIT key is inserted into the slot machine 1 and invokes the audit menu (S100). If the audit menu is not invoked (S100:NO), the step S100 is executed repeatedly and entering a standby state.

If the audit menu is invoked, the main CPU 71 causes the liquid crystal display device 134 to display a top screen which is not shown (S101). Next, the main CPU 71 judges whether the “GAME SETTINGS” is selected in the top screen (S102). If the “GAME SETTINGS” is not selected (S102: NO),the main CPU 71 judges whether it is requested to end the audit menu (S103), and if it is requested to end the audit menu (S103: NO), the present routine is over and the slot machine 1 is restarted. Thereby, changes of the setting are reflected to the game states of the slot machine 1. In addition, if the setting is not changed from the time when the audit menu is invoked, it may be not restarted. If it is not requested to end the audit menu (S103: NO), another setting process is performed and return to S101.

If the “GAME SETTINGS” is selected in the step S102 (S102: YES), the main CPU 71 causes the liquid crystal display device 134 to display the setting item screen (refer to the FIG. 7) (S105). Next, the main CPU 71 judges whether the effect setting item 1341 is selected in the setting item screen (S106). If the effect setting item 1341 is not selected (S106: NO), entering the standby state. If the effect setting item 1341 is selected (S106: YES), the main CPU 71 causes the liquid crystal display device 134 to display the setting content selection screen (refer to the FIG. 8) (S107).

Next, the main CPU 71 judges whether the theme 1342 is selected in the setting content selection screen (S108). If the theme 1342 is not selected (S108: NO), entering the standby state. If the theme 1342 is selected (S108: YES), the main CPU 71 judges whether the selected setting item is a sound category (S109). If the selected setting item is the sound category (S109: YES), the main CPU 71 causes the liquid crystal display device 134 to display the sound test screen (refer to the FIG. 10) (S110). Then, the main CPU 71 judges whether the audition button image 1343 is touched in the sound test screen (S111). If the audition button image 1343 is touched, the main CPU 71 outputs a sound corresponding to the selected theme (S112). At this moment, the frame image 1343A is displayed around the audition button image 1343 and the audition button image 1343 is shown in a highlighted manner.

Then, for example, the main CPU 71 determines the setting content (S113) if the OK button 1361 or the CANCEL button 1362 is touched in the sound test screen, after a sound is output in the step S112. If when it is judged that the setting item is not the sound category in the step S109 (S109: NO), the main CPU 71 determines the setting content of the theme which is selected in S108 (S113).

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

What is claimed is:

1. A gaming machine comprising:
a display device including a touch panel and displaying a setting screen by which a plurality of effect setting items including sound category of a game are set;
a controller controlling the setting screen according to an input to the touch panel;
a memory in which each of the plurality of effect setting items is associated with multiple themes, and a setting content corresponds to each of the multiple themes of the each of the plurality of effect setting items; and
a speaker outputting the sound,
wherein the controller:
causes the setting screen to display the plurality of effect setting items in a selectable manner;
causes the setting screen to display the multiple themes in a selectable manner, when one of the plurality of effect setting items is selected;
causes the display device to display an audition button image when a selected effect setting item is a category of the sound and one of the multiple themes is selected; and
causes the speaker to output a sound of the setting content corresponding to the selected theme, when the audition button image is touched.

2. The gaming machine according to the claim 1, wherein,
the controller performs an ON/OFF control to an output of the sound of the speaker each time the audition button image is touched, and the audition button image is displayed in a highlighted manner when the output of the sound is ON.
